(19) United States
(12) Patent Application Publication
(10) Pub. No.: US 2024/0301125 A1
(43) Pub. Date: Sep. 12, 2024

(54) Lignin-Based Epoxide Prepolymers, Polymers, Related Compositions, and Related Methods

(71) Applicant: BOARD OF TRUSTEES OF MICHIGAN STATE UNIVERSITY, East Lansing, MI (US)

(72) Inventors: Mojgan Nejad, Okemos, MI (US); Saeid Nikafshar, East Lansing, MI (US)

(21) Appl. No.: 18/268,391

(22) PCT Filed: Dec. 21, 2021
(86) PCT No.: PCT/US21/64513

§ 371 Date: Jun. 20, 2023

Related U.S. Application Data
(60) Provisional application No. 63/129,433, filed on Dec. 22, 2020.

(51) Int. Cl. C08G 59/06; C08G 59/50; C09D 163/00

(52) U.S. Cl. CPC C08G 59/063; C08G 59/502; C09D 163/00

(57) ABSTRACT

The disclosure relates to epoxidized lignin prepolymers, related methods of making the prepolymers, cured epoxy resins formed from the prepolymers, articles including a coating of the cured epoxy resins, and related curing methods and compositions. The epoxidized lignin prepolymer has an epoxide functionality in a range of 2 to 8 and a high solubility in various common organic solvents. The high solubility permits incorporation of the epoxidized lignin prepolymer into an epoxy system which cures after addition of curing agents at high enough concentrations to allow replacement of conventional epoxide prepolymers at levels up to 100% replacement. Using other biobased materials in addition to lignin, for example biobased epichlorohydrin to epoxidize the lignin and a biobased hardener to cure the prepolymer, can provide a corresponding cured epoxy resin that is formed from completely biobased materials.

### CROSS REFERENCE TO RELATED APPLICATION

Priority is claimed to U.S. Provisional Application No. 63/129,433 filed on Dec. 22, 2020, which is incorporated herein by reference in its entirety.

### STATEMENT OF GOVERNMENT INTEREST

None.

### BACKGROUND OF THE DISCLOSURE

### Field of the Disclosure

The disclosure relates to epoxidized lignin prepolymers, related methods of making the prepolymers, cured epoxy resins formed from the prepolymers, articles including a coating of the cured epoxy resins, and related curing methods and compositions. The epoxidized lignin prepolymer has an epoxide functionality in a range of 2 to 8 and a high solubility in various common organic solvents. The prepolymer can corresponding cured resin can be formed from completely biobased materials.

### Background of the Disclosure

Most epoxy resins are currently produced from petroleum-derived chemicals, which are used for adhesive, coating, electronic, and composite applications due to their versatile properties. One of the most common types of epoxy resin is diglycidyl ether bisphenol A (DGEBA), which has excellent chemical and mechanical properties. This resin forms a crosslinked network by adding different hardeners, like polyamines, polyamides, anhydrides, and mercaptans, to cure epoxy resin at different temperatures. In recent years, due to fluctuations in the price of oil, increased greenhouse gas emissions, and health and environmental issues, there have been serious efforts in replacing fossil-fuel based chemicals with biobased materials. Bisphenol A (BPA), which is used as the main raw material in the production of DGEBA epoxy resin, comprises more than 67% of the molar mass of DGEBA. It has detrimental effects on human health and the environment; and has been shown to act as an endocrine disruptor that is highly toxic for living organisms. BPA has been banned for use in food packaging, food-related materials, and baby bottles. Therefore, it is of great interest to identify alternative, renewable, and sustainable raw materials that can substitute BPA in the epoxy resin formulation.

Several biobased aromatic compounds have been used to synthesize epoxy resin, including itaconic acid, eugenol, rosins, gallic acid, vanillins, vanillic acid, soybean oil, as well as lignin. Epoxy resin is conventionally prepared by reacting epichlorohydrin (ECH) with the hydroxyl groups of BPA under alkaline conditions and using sodium hydroxide as a catalyst. There are some challenges in using lignin to replace BPA, such as high polydispersity index and molecular weight, different types of hydroxyl groups, and low solubility in organic solvents and water. These attributes cause lignin to have lower reactivity toward ECH than BPA and possibly result in resin with lower homogeneity. Lignin can be incorporated into epoxy resin via three different methods: 1) blending with petroleum-based epoxy resin, 2) modification of lignin followed by epoxidation, and 3) epoxidation of unmodified lignin. Although many studies have focused on utilizing lignin in epoxy resin, they mostly used modified lignin (fractionated or lignin monomers). The extra cost associated with lignin fractionation and using lignin monomers in epoxy resin formulation has not been viewed favorably by industry.

### SUMMARY

In one aspect, the disclosure relates to an epoxidized lignin prepolymer comprising: a reaction product between: an unmodified lignin, and a halogenated alkyl epoxide; wherein: the reaction product has an epoxide functionality in a range of 2 to 8; and the reaction product has a solubility of at least 10 wt. % in common organic solvents such as one or more of dimethyl formamide (DMF), acetone, and methyl ethyl ketone.

The epoxide functionality represents the average number of epoxide (or oxirane) functional groups per lignin macromolecule (e.g., as a number- or weight-average), for example expressed as an amount of epoxy groups (e.g., mol epoxy/g lignin) times the lignin number-average molecular weight (Mn) (e.g., g lignin/mol lignin). In some embodiments, the epoxide functionality can be at least 2, 2.5, 3, 3.5, or 4 and/or up to 4, 4.5, 5, 5.5, 6, 7, or 8. The epoxide functionality can be controlled by selection of the lignin source (e.g., having a source-dependent distribution of functional groups reactive to epoxidation) and/or relative amount of halogenated alkyl epoxide reacted with the unmodified lignin and/or the relative amount of phase catalyst transfer. Different epoxide functionality values can be desirable depending on the relative degree of crosslinking desired in the eventual cured thermoset product, which degree of crosslinking is proportional to the epoxide functionality.

The reaction product (e.g., an epoxide-functional resin as the prepolymer) is generally substantially non-crosslinked, which is advantageous because it prevents the reaction product from gelling or precipitating during formation of the epoxidized lignin prepolymer, and it allows the reaction product to be dissolved at sufficiently high concentrations in a variety of useful organic solvents. Such high solubility permits incorporation of the epoxidized lignin prepolymer into an epoxy system which cures after addition of curing agents (e.g., for both 1K or 2K formulations) at high enough concentrations to allow replacement of conventional epoxide prepolymers such as DGEBA at levels up to 100% replacement, which in turn reduces the amount of dangerous or toxic components such as BPA (e.g., as a health or environmental hazard) used in a cured coating or other products. Such reduction of dangerous components is achieved with replacement by the epoxidized lignin prepolymer, which is a biobased component. For example, the reaction product and/or corresponding epoxidized lignin prepolymer has high solubility in common organic solvents, for example being miscible or completely dissolvable in an organic reference solvent at 20° C. or 25° C. in an amount of at least 0.05 g/ml, 0.1 g/ml and/or up to 0.5 g/ml or 1 g/ml. Alternatively or additionally, the solubility of the epoxidized lignin prepolymer in an organic reference solvent at 20° C. or 25° C. can be expressed on a w/w basis, for example being soluble in amounts of at least 10, 15, 20, 25, 30, 35, or 40 wt. % and/or up to 20, 30, 40, 50, 60, 70, or 80 wt. % of epoxidized lignin prepolymer relative to the total reference solution (i.e., prepolymer and solvent combined). Such values reflect concentrations at which the epoxidized lignin prepolymer is 100% soluble in a given solvent after mixing at room temperature to provide a solution with no residual solid. The reference solvent is not particularly limited and can include those solvents useful for forming a curable epoxy formulation, for example including dimethyl formamide (DMF), dimethyl sulfoxide (DMSO), dichloromethane (DCM), acetone, methyl ethyl ketone, etc. The reference solvent is selected as a convenient means to characterize the product solubility, but it does not limit the solvents used when forming a cured thermoset using the prepolymer product.

Various refinements of the disclosed epoxidized lignin prepolymer are possible.

In a refinement, the unmodified lignin is derived from a biomass selected from the group consisting of hardwoods, softwoods, grasses, and combinations thereof. The lignin is not particularly limited and generally can include lignin from any lignocellulosic biomass. Plants, in general, are comprised of cellulose, hemicellulose, lignin, extractives, and ash. Lignin typically constitutes 15-35 wt. % of woody plant cell walls, is an amorphous aromatic polymer made of phenylpropane units (e.g., coniferyl alcohol, sinapyl alcohol, p-coumaryl alcohol). The lignin for use according to the disclosure is not particularly limited to the source of lignin or its isolation method. Any type of lignin regardless of the biomass type (hardwood, softwood and grasses) isolated through any extraction methods (such as Kraft, soda, organosolv, sulfite, enzymatic hydrolysis, and Ionic liquid) is suitable for use in the disclosed compositions and articles.

Unmodified lignin as used herein refers to lignin that has been separated from other components of its lignocellulosic biomass feedstock, such as the cellulose, hemicellulose, and other plant material components. Such separation processes (e.g., Kraft, soda, organosolv, sulfite, enzymatic hydrolysis, and ionic liquid) to isolate lignin from biomass may hydrolyze or otherwise fragment larger lignin molecules into smaller fragments, but this fragmentation and molecular weight reduction is still considered to provide an unmodified lignin as used herein in the corresponding compositions and methods. Such isolated lignins, which are also known as technical lignins, have not been subjected to further modifications or fragmentations, and are considered to provide an unmodified lignin as used herein in the corresponding compositions and methods. Modifications (or chemical modifications) that are generally avoided for the lignin used herein can include one or more of demethylation, phenolation, hydroxymethylation, etherification, depolymerization, and fractionation to monomer, dimers, trimers and oligomers.

The unmodified lignin is generally polymeric, as contrasted with various lignin monomers such as one or more of coniferyl alcohol, sinapyl alcohol, and p-coumaryl alcohol. For example, the unmodified lignin can have an average molecular weight (e.g., weight-average molecular weight, Mw) of at least 500 g/mol. While technical lignins or other commercial lignins isolated from biomass could have some lignin monomers in the distribution of lignin components, the fraction of such lignin monomers in the unmodified lignin is suitably small, for example as reflected by the minimum average molecular weight of the unmodified lignin. In some embodiments, the unmodified lignin contains less than 10, 5, 2, 1, 0.5, 0.2, or 0.1 wt. % lignin monomers relative to the total unmodified lignin.

In a refinement, the unmodified lignin is isolated from an extraction process selected from the group consisting of Kraft extraction, soda extraction, organosolv extraction, enzymatic hydrolysis extraction, ionic liquid, extraction, sulfite extraction, and combinations thereof.

In a refinement, the unmodified lignin, prior to incorporation into the reaction product, has at least one of the following properties: an average molecular weight in a range of 500 to 50000 (e.g., weight-average molecular weight (M_{w}); a polydispersity in a range of 1.2 to 10; an aliphatic hydroxyl content in a range of 0.5 to 7 mmol/g; a phenolic hydroxyl content in a range of 1 to 7 mmol/g; a carboxylic hydroxyl in a range of 0.1 to 2.0 mmol/g; and a total hydroxyl content in a range of 2 to 10 mmol/g. In various embodiments, the unmodified lignin, prior to reaction and/or incorporation into a reaction mixture for formation of the reaction product, suitably can be selected to have one or more properties related to molecular weight, molecular weight distribution, hydroxyl content, and hydroxyl content distribution. Selection of various physical and chemical properties of the unmodified lignin can help to limit, reduce, or prevent crosslinking and/or gel formation during preparation of the epoxidized lignin prepolymer.

For example, a lower molecular weight and/or a lower polydispersity index can be desirable to promote access to and reactivity of the phenolic (or aromatic) hydroxy groups of the lignin, but lignin with any molecular weight and/or polydispersity can be used. Suitably, the weight-average molecular weight (M_{w}) can be in a range of 500 to 50000, 1000 to 3000, 3000 to 7000, 3000 to 10000, or 10000 to 50000. For example, M_{w} independently can be at least 500, 800, 1000, 1500, 2000, or 3000 and/or up to 1000, 1200, 1500, 2000, 3000, 5000, 7000, 10000, 15000, or 50000, but higher values are possible. Similar ranges can apply to the number-average molecular weight (Mₙ). Alternatively or additionally, the polydispersity index (M_{w}/Mₙ) can be in a range of 1.2 to 10, 1.2 to 5, or 2 to 4, for example being at least 1.2, 1.4, 1.6, 1.8, or 2 and/or up to 1.5, 1.8, 2.0, 3.0, 4.0, 5.0, 6.0, or 10, but higher values are possible.

Similarly, phenolic (or aromatic) hydroxyl groups can be desirable to promote reactivity of the lignin hydroxyl groups with the halogenated alkyl epoxide. For example, in the case of ECH, reactivity with lignin hydroxyl groups is generally greatest for phenolic hydroxyl groups, followed by carboxylic acid hydroxyl groups and then by aliphatic hydroxyl groups. Selection of an unmodified lignin with a relatively higher phenol hydroxyl content can limit or reduce the number of unreacted lignin hydroxyl groups which could otherwise react with epoxy groups during preparation of the epoxidized lignin prepolymer to form undesirable crosslinks. Similarly, selection of an unmodified lignin with a relatively lower carboxylic acid hydroxyl content can limit or reduce potential hydrolysis after formation of the epoxidized lignin prepolymer or the eventual corresponding cured composition, thus increasing the potential service life of the cured composition or coating. In a refinement, the aliphatic hydroxyl content of the unmodified lignin can be in a range of 0.5 to 7 mmol/g, 1 to 4 mmol/g, or 1 to 3 mmol/g, for example being at least 0.5, 1, 1.5 or 2 and/or up to 2, 2.5, 3, 3.5, 4, 5, 6, or 7 mmol/g. In a refinement, the phenol hydroxyl content of the unmodified lignin can be in a range of 1 to 7 mmol/g, 2 to 6 mmol/g, or 3 to 6 mmol/g, for example being at least 1, 1.5, 2, 2.5, 3, or 3.5 and/or up to 3, 3.5, 4, 4.5, 5, 5.5, 6, or 7 mmol/g. Alternatively or additionally, the phenol hydroxyl content can be at least 40, 50, 60, or 70% and/or up to 60, 65, 70, 75, or 80% of the total hydroxyl groups of the unmodified lignin (e.g., aliphatic, phenolic/aromatic, and carboxylic hydroxyl groups combined). Similarly, the phenol hydroxyl content individually can be greater than the aliphatic hydroxyl content individually and the carboxylic hydroxyl content individually. In a refinement, the carboxylic hydroxyl content of the unmodified lignin can be less than 1 mmol/g or 2 mmol/g, for example being at least 0.01, 0.1, or 0.2 and/or up to 0.2, 0.3, 0.4, 0.5, 0.7, 1, 1.5, or 2 mmol/g. In a refinement, the total hydroxyl content of the unmodified lignin can be in a range of 2 to 10 mmol/g, 3 to 9 mmol/g, or 4 to 7 mmol/g, for example being at least 2, 2.5, 3, 3.5, 4, 4.5, or 5 and/or up to 3.5, 4, 4.5, 5, 6, 7, 8, 9, or 10 mmol/g.

In a refinement, the epoxidized lignin prepolymer has an aliphatic hydroxyl content in a range of 50% to 100% relative to an aliphatic hydroxyl content of the unmodified lignin, prior to incorporation into the reaction product. Similarly, the epoxidized lignin prepolymer can have a phenolic hydroxyl content of not more than 1% relative to a phenolic hydroxyl content of the unmodified lignin, prior to incorporation into the reaction product. Alternatively or additionally, the epoxidized lignin prepolymer can have one, two, or three of the following properties: an aliphatic hydroxyl content in a range of 0.5 to 7 mmol/g; a phenolic hydroxyl content of less than 0.1 mmol/g; and a carboxylic hydroxyl content of less than 0.05 mmol/g

In a refinement, the unmodified lignin, prior to incorporation into the reaction product, has the following properties: a number-average molecular weight (Mₙ) in a range of 500 to 5000 (or 1000 to 3000); a polydispersity in a range of 1.2 to 8 (or 2 to 4); a phenol hydroxyl content in a range of 1 to 7 mmol/g (or 2 to 5 mmol/g); a relative phenol hydroxyl content of at least 45% (or at least 55%) relative to hydroxyl groups of the unmodified lignin; and a carboxylic hydroxyl content less than 1 mmol/g (or less than 0.5 mmol/g).

In a refinement, the epoxide functionality of the reaction product is in a range of 3.5 to 6.

In a refinement, the reaction product is soluble (e.g., completely or 100% soluble) in DMF at a concentration of at least 0.1 g/ml at 25° C., or at a concentration of 15 wt. % to 40 wt. % at 25° C.

In a refinement, the halogenated alkyl epoxide comprises epichlorohydrin (“ECH” or 2-(chloromethyl)oxirane). In various embodiments, other 2-(halomethyl)oxiranes can be used.

In a refinement, the halogenated alkyl epoxide is a biobased material. The halogenated alkyl epoxide can be derived from a biobased feedstock, for example having a carbon isotope signature corresponding to recently fixated carbon and not from a radioactively degraded petroleum source. For example, biobased-ECH can be formed from a biobased glycerin feedstock (e.g., obtained from natural fatty acid (tri)glycerides or other natural glycerin sources). In other embodiments, petroleum-based ECH or other halogenated alkyl epoxides can be used.

In another aspect, the disclosure relates to a method for making an epoxidized lignin prepolymer according to any of the variously disclosed embodiments and refinements, the method comprising: performing a glycidation reaction in a reaction mixture comprising an unmodified lignin and a halogenated alkyl epoxide, thereby forming a lignin adduct in the reaction mixture and comprising pendant epoxide groups and pendant halogenated alkyl hydroxy groups; and performing a quenching reaction in the reaction mixture containing the lignin adduct by adding a base in a controlled manner to the reaction mixture, thereby forming an epoxidized lignin prepolymer by converting at least a portion of the pendant halogenated alkyl hydroxy groups to pendant epoxide groups (e.g., a ring-closing or epoxide re-formation step) while limiting or preventing gelation of the reaction mixture. The epoxidized lignin prepolymer reaction product can have any of the various features and parameters discussed above.

The lignin adduct is generally an intermediate product mixture prior to formation of the eventual epoxidized lignin prepolymer after quenching. The lignin adduct includes pendant epoxide groups resulting from SN2 addition during glycidation. The lignin adduct also includes pendant halogenated alkyl hydroxy groups resulting from epoxide ring-opening addition during glycidation. Both pendant functional groups can be added to the lignin substrate by reaction at a hydroxyl site of the starting unmodified lignin (e.g., anionic form of the hydroxyl site after addition of suitable catalyst).

The quenching reaction is generally performed after or otherwise in series with the glycidation reaction. The base is not particularly limited, and aqueous sodium hydroxide (or other alkali metal or alkine earth metal hydroxide) is conveniently used a low-cost base to perform the quenching reaction while maintaining the epoxidized lignin prepolymer in solution in the combined resulting solvent/aqueous medium. By adding the base to the reaction mixture in a slow, controlled manner during the quenching reaction, the base is preferentially consumed in a ring-closing reaction with the pendant halogenated alkyl hydroxy groups to re-form the epoxide group. For example, ring-opening addition with ECH can form a pendant —OCH₂CH(OH)CH₂Cl group as the halogenated alkyl hydroxy group. Reaction with NaOH as a representative base can abstract an H and Cl atom from the halogenated alkyl hydroxy group to re-form the epoxide group pendant on the lignin along with NaCl and H₂O byproducts. In contrast, if the entire amount of base were added to the reaction mixture initially or otherwise at a large excess early in the quenching reaction, the excess base could undesirably cause excessive crosslinking and gelation by reaction between existing epoxide groups (e.g., those resulting from SN2 addition during glycidation) and existing hydroxyl groups (e.g., those resulting from ring-opening during glycidation or those originally in the unmodified lignin that were not converted during glycidation). Accordingly, slow, controlled addition of the base to the reaction mixture (e.g., dropwise addition) can limit or prevent undesirable crosslinking and gelation, for example by slowly adding the entire amount of base to the reaction mixture distributed in smaller amounts over the total quenching reaction time.

While some crosslinking might occur during the quenching reaction, any such crosslinking is reduced or minimized to an extent such that precipitation of an insoluble crosslinked or networked reaction product, which would be indicative of gelation, is not observed. Put another way, the formation of new bonds linking lignin structures is reduced, resulting in a prepolymer that has high solubility in organic solvent. Accordingly, essentially all of the reaction product after glycidation and quenching remains soluble in the final reaction medium, which contains any solvent from the initial reaction medium, the epoxidized lignin prepolymer reaction product, any water added with the base in aqueous form, etc. For example, at least 90, 95, 98, or 99 wt. % and/or up to 98, 99, or 100 wt. % of the reaction product remains soluble in the final reaction medium. Alternatively, not more than 1, 2, 5, or 10 wt. % of the reaction product precipitates or gels in the reaction medium. Precipitation, gelation, and/or the absence thereof can be suitably monitored/confirmed via visible inspection, filtration, or optical interrogation (e.g., to confirm whether any precipitate formed during the reaction). The desired, substantially uncrosslinked/non-gelled reaction product that has high solubility in various other solvents (e.g., for 1K or 2K coating formulations) can be recovered from the final reaction medium, for example by first removing (e.g., filtering) any minor amounts of precipitate that did form, and then recovering the desired product by inducing precipitation of the desired product with addition of a large excess of (de-ionized) water.

Various refinements of the disclosed method for forming an epoxidized lignin prepolymer are possible.

In a refinement, the method comprises performing the glycidation reaction at a temperature in a range of 50° C. to 70° C. The glycidation reaction more generally is performed at an elevated temperature (e.g., above 25° C.) to improve the rate and yield of the epoxidation reaction, thereby improving the epoxide functionality of the eventual (final) reaction product and epoxidized lignin prepolymer. Excessively high reaction temperatures, however, can undesirably lead to crosslinking and/or thermal run-away. Accordingly, suitable reaction temperatures for the glycidation reaction can be in the range of 50° C. to 70° C. or 55° C. to 65° C., for example about 65° C. Suitable reaction times (or residence times in a continuous reactor) for the glycidation reaction can be in the range of 0.5-5 hr or 1-4 hr, for example about 3 hr. Suitably, the glycidation reaction is performed in the absence of a base or base catalyst (e.g., NaOH, whether the same or different from the base added during quenching).

In a refinement, the method comprises performing the quenching reaction at a temperature up to 30° C. The quenching reaction more generally is performed at a low or ambient (e.g., room-) temperature, to allow the ring-closing/epoxide re-formation reaction to proceed without substantial crosslinking or gelation. Accordingly, suitable reaction temperatures for the quenching reaction can be in the range of 5° C. to 30° C. or 15° C. to 25° C., for example about 20° C. or 25° C.

In a refinement, the method comprises performing the quenching reaction over a reaction time of 6 hr to 24 hr. Suitable reaction times (or residence times in a continuous reactor) for the quenching reaction more generally can be in the range of 1-24 hr or 3-12 hr, for example about 6 hr or 8 hr. For example, the quenching reaction time can be at least 1, 2, 3, 4, 6, 8, or 10 hr and/or up to 3, 6, 8, 10, 12, 16, or 24 hr. The quenching reaction time can reflect the time over which the total amount of base for ring-closing/epoxide re-formation is added.

In a refinement, the reaction mixture further comprises a solvent. The solvent is not particularly limited and can be any suitable liquid solvent medium for the reaction mixture that can solubilize or be miscible with the unmodified lignin and the halogenated alkyl epoxide. Typical solvents can include dimethylformamide (e.g., for any lignin in general) and acetone (e.g., for organsolv lignin in particular). More general examples of solvents include one or more of acetone, tetrahydrofuran (THF), 2-butanone, other ketones (e.g., methyl n-propyl ketone, methyl isobutyl ketone, methyl ethyl ketone, ethyl n-amyl ketone), esters (e.g., C₁-C₄ alkyl esters of C₁-C₄ carboxylic acids, such as methyl, ethyl, n-propyl, butyl esters of acetic acid such as n-butyl acetate, etc., n-butyl propionate, ethyl 3-ethoxy propionate), dimethylformamide, dimethyl carbonate, 1,4 dioxane, dichloromethane, dimethylformamide (DMF), dimethylsulfoxide (DMSO), etc., for example as single solvents or solvent mixtures. The solvent or solvent mixture can be included in any suitable amount in the reaction mixture, for example in amount of at least 5, 10, 15, 20, or 30 wt. % and/or up to 20, 30, 40, 50, 60, 70, or 80 wt. % relative to the total amount of solvent(s), (initial) unmodified lignin, and (initial) halogenated alkyl epoxide in or added to the reaction mixture.

In a refinement, the method comprises performing the glycidation reaction and the quenching reaction in the presence of a phase-transfer catalyst. The phase-transfer catalyst generally serves to transfer an anionic form of hydroxyl groups to an organic phase (e.g., —O—), for example which is stabilized in the reaction medium by a corresponding cation from the phase-transfer catalyst. The anionic form of the hydroxyl groups is amenable to reaction with the halogenated alkyl epoxide via SN2 and ring-opening addition. Phase-transfer catalysts are generally known in the art. Suitable phase-transfer catalysts include tetrabutyl ammonium bromide (TBAB) or triethylbenzyl ammonium chloride (TEBAC), for example in a general class of quaternary ammonium salts such a halogen salt (e.g., F, Cl, Br) of an ammonium cation having four alkyl and/or aromatic substituents. The representative reaction Scheme 1 below illustrates formation of the anionic —O⁻ groups, reaction of same with halogenated alkyl epoxide during glycidation, and epoxide re-formation/ring closing during quenching. The phase-transfer catalyst can be included during the quenching reaction (e.g., added as an additional portion relative to that added during glycidation) to provide additional time for glycidation for unreacted ECH and lignin hydroxyl groups during the quenching, thus improving the epoxy content of final reaction product, because the phenolic ion transfer in the last step is still ongoing and causes higher net epoxy content.

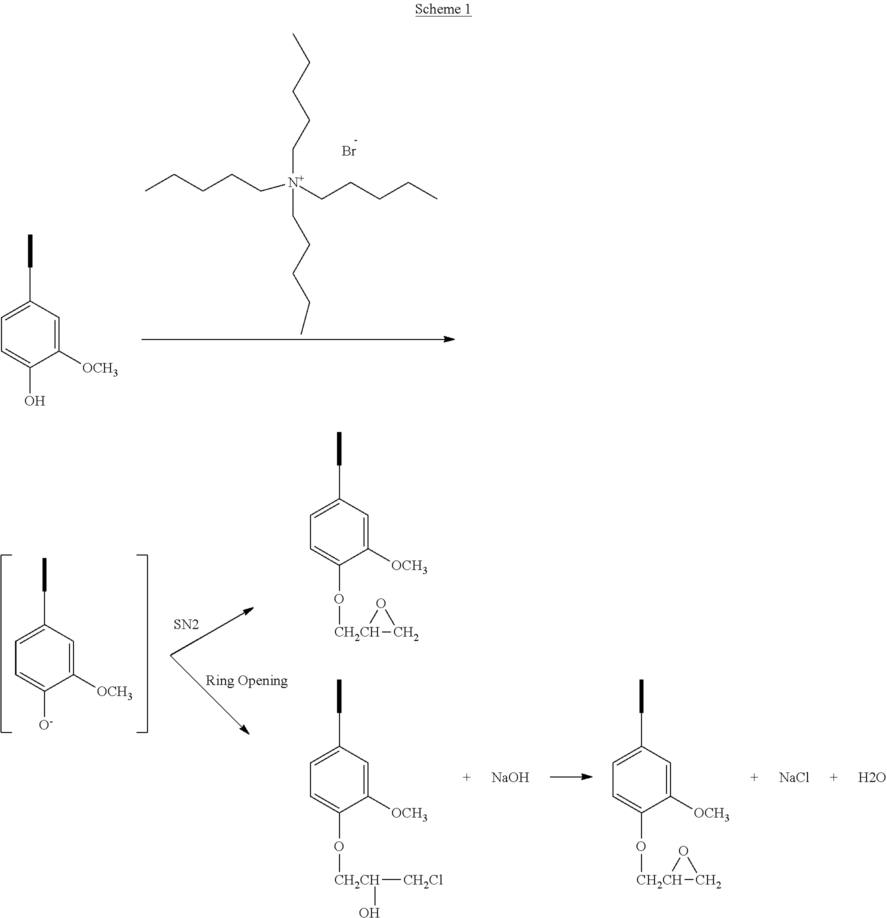

In another aspect, the disclosure relates to a cured epoxy resin comprising: a crosslinked reaction product between (i) the epoxidized lignin prepolymer according to any of the variously disclosed embodiments and refinements and (ii) a hardener. The hardener is suitably a polyfunctional monomer having a functional group reactive with the epoxide (oxirane) groups of the epoxidized lignin prepolymer, which react via ring-opening to covalently bond the hardener to the prepolymer and form a pendant hydroxyl group. The cured epoxy resin is generally a networked or thermoset material. The epoxidized lignin prepolymer reaction product can have any of the various features and parameters discussed above.

Various refinements of the disclosed cured epoxy resin are possible.

In a refinement, the hardener is selected from the group consisting of polyfunctional amines, acids, acid anhydrides, phenols, alcohols, thiols, and combinations thereof. The hardener is not particularly limited and can be selected from various conventional hardeners used for epoxy resins.

In a refinement, the hardener is a biobased material. Example materials suitable as biobased hardeners include biobased amines, phenalkamines, furanyl amines, anhydrides, and polyphenols. As illustrated in the examples, a phenalkamine isolated from cashew nutshells is a suitable biobased hardener and is available as the commercial product CARDOLITE GX-3090.

In a refinement, the epoxidized lignin prepolymer is substantially the only source of epoxide-hardener crosslinks in the crosslinked reaction product. The epoxidized lignin prepolymer is suitably a 100% replacement for conventional epoxide polymer or prepolymer resins prior to curing, such as bisphenol-A-diglycidyl ether (DGEBA). Accordingly, a composition to be cured/crosslinked including an epoxide-functional component and a hardener component is suitably substantially free from epoxide-functional components other than the epoxidized lignin prepolymer. For example, at least 80, 90, 95, 98, or 99% and/or up to 90, 95, 99, or 100% (e.g., about 100%) of the epoxide-hardener crosslinks in the crosslinked reaction product are from the reaction of the epoxidized lignin prepolymer with the hardener, for example on a weight basis (of the epoxide-functional components) or a number/molar basis (of the epoxide groups prior to curing).

In a refinement, the cured epoxy resin is 100% biobased. The cured epoxy resin can be 100% biobased when the halogenated alkyl epoxide is a biobased material (e.g., biobased ECH) and the hardener is a biobased material, given that the lignin substrate forming the primary basis for the cured epoxy resin is also a biobased material.

In another aspect, the disclosure relates to an article (e.g., coated article) comprising: (a) a substrate; and (b) a cured epoxy resin according to any of the variously disclosed embodiments and refinements coated on a surface of the substrate. The cured epoxy resin according to the disclosure can be used for the same applications as a conventional cured epoxy, for example as a (protective) coating or paint on a substrate, an adhesive material joining two opposing substrates, and composites serving as polymeric matrix in composite products mixed with different type of natural or synthetic fibers/filler or extenders, etc. The cured epoxy resin can have any of the various features and parameters discussed above.

In a refinement of the disclosed article, the substrate is selected from the group of metal, plastics, a different thermoset material, glass, wood, fabric (or textile), composites, and ceramics. The substrate is not particularly limited, and generally can be formed from any material. For example, the substrate can be a metal, plastic, glass, wood, fabric (or textile), or ceramic material. Examples of specific metals include steel, aluminum, copper, etc. Examples of specific plastics include polyvinyl alcohol (PVOH), ethylene vinyl alcohol (EVOH), polyethylene terephthalate (PET), polypropylene (PP), polyethylene (PE), polylactic acid (PLA), etc. Suitable wood materials can be any type of wood commonly used in home, office, outdoor settings, wood composites, mass timber and engineered wood products. Suitable glass materials can be those used for building windows, automobile windows, etc. In some embodiments, the substrate is a top layer of a coating or series of coatings on a different underlying substrate. For example, the coated article can include a substrate material as generally disclosed herein, one or more intermediate coatings on the substrate (e.g., a polyurethane coating, an acrylic coating, another primer coating, etc.), and the cured epoxy resin on the one or more intermediate coatings as the final, external coating on the coated article.

The cured epoxy resin can have any desired thickness on the substrate(s). In a refinement of the disclosed article, the cured epoxy resin has a thickness ranging from 0.01 μm to 500 μm, for example at least 0.01, 10, 20, 50, or 100 μm and/or up to 200, 500 μm. Typical cast coatings can have thicknesses of 10 μm to 100 μm. Typical spin coatings can have thicknesses of 0.05 μm or 0.10 μm to 0.20 μm or 0.50 μm. Multiple coating layers can be applied to substrate to form even thicker layers of the cured epoxy resin (e.g., above 500 μm or otherwise) if desired.

In another aspect, the disclosure relates to a method for forming a cured epoxy resin, the method comprising: reacting the epoxidized lignin prepolymer according to any of the variously disclosed embodiments and refinements with a hardener. The epoxidized lignin prepolymer and the hardener can be provided in a liquid formulation, for example dissolved in a solvent medium (e.g., those described above for the reaction medium). The epoxidized lignin prepolymer and the hardener can be provided in the same or separate curing formulations (e.g., 1K or 2K formulations). The high solubility of the epoxidized lignin prepolymer in various solvents permits its inclusion at relatively high concentration levels in the liquid formulation to be cured, for example at least 10, 15, 20, 25, 30, 35, or 40 wt. % and/or up to 20, 30, 40, 50, 60, or 70 wt. % in a suitable organic solvent at 20° C. or 25° C. at high enough concentrations to allow replacement of conventional epoxide prepolymers. The epoxidized lignin prepolymer reaction product can have any of the various features and parameters discussed above.

In another aspect, the disclosure relates to an aqueous curable epoxy composition comprising: an aqueous medium; and an organic phase dispersed in the aqueous medium, the organic phase comprising the epoxidized lignin prepolymer according to any of the variously disclosed embodiments and refinements and a hardener. The organic phase can simply be a liquid hardener (e.g., a water-insoluble material) that serves as a pH increaser or solvent/liquid medium for the epoxidized lignin prepolymer which is dissolved therein. The curable composition can thus have an aqueous continuous medium with droplets of miscible prepolymer and hardener dispersed throughout the aqueous medium. The aqueous dispersion can be stored until use, whereupon it can be applied to a surface to evaporate water and complete curing (e.g., initial curing can begin while in aqueous dispersion before use, albeit at a slow rate).

While the disclosed methods, compositions, and articles are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE DRAWINGS

For a more complete understanding of the disclosure, reference should be made to the following detailed description and accompanying drawings wherein:

FIG. 1 is a representative reaction scheme illustrating glycidation and quenching steps according to the disclosure.

FIG. 2 is a ³¹P NMR spectrum of a representative unmodified lignin illustrating potential hydroxyl groups for prepolymer formation.

FIG. 3 is a representative reaction scheme illustrating the synthesis (top reaction) and curing (bottom reaction) of epoxidized lignin according to the disclosure.

FIG. 4 is a 1H NMR spectrum of representative epoxidized lignin according to the disclosure.

FIG. 5 includes ³¹P NMR spectra for (A) an unmodified softwood lignin (SW) and (B) a corresponding epoxidized lignin prepolymer (E-SW) showing selective reaction of phenolic hydroxyl groups for epoxidation and retention of aliphatic hydroxyl groups in the final prepolymer.

FIG. 6 includes ³¹P NMR spectra for (A) an unmodified hardwood lignin (HW) and (B) a corresponding epoxidized lignin prepolymer (E-HW) showing selective reaction of phenolic hydroxyl groups for epoxidation and retention of aliphatic hydroxyl groups in the final prepolymer.

### DETAILED DESCRIPTION

The disclosure relates to epoxidized lignin prepolymers, related methods of making the prepolymers, cured epoxy resins formed from the prepolymers, articles including a coating of the cured epoxy resins, and related curing methods and compositions. The epoxidized lignin prepolymer has an epoxide functionality in a range of 2 to 8 and a high solubility in various common organic solvents, for example being completely soluble at concentrations of at least 10 wt. % or 0.1 g/ml in a reference solvent such as dimethyl formamide, acetone, or methyl ethyl ketone. The high solubility permits incorporation of the epoxidized lignin prepolymer into an epoxy system which cures after addition of curing agents at high enough concentrations to allow replacement of conventional epoxide prepolymers at levels up to 100% replacement, which in turn reduces the amount of dangerous or toxic components in conventional epoxides. Using other biobased materials in addition to lignin, for example biobased epichlorohydrin to epoxidize the lignin and a biobased hardener to cure the prepolymer, can provide a corresponding cured epoxy resin that is formed from completely biobased materials.

### Reactants

An epoxidized lignin prepolymer according to the disclosure is generally a reaction product between an unmodified lignin and a halogenated alkyl epoxide. In particular, reactive hydroxy groups (e.g., phenolic hydroxy groups) in the unmodified lignin react with the halogenated alkyl epoxide to form an ether link between the base lignin structure (e.g., an aromatic component thereof) and the alkyl epoxide in the epoxidized lignin prepolymer. The resulting epoxidized lignin prepolymer has a plurality of pendant reactive epoxide or oxirane groups on the original (unmodified) lignin backbone.

Lignin is widely available, renewable, sustainable, and inedible material that does not compete with food resources like other renewable materials such as vegetable oils. Lignin is the most abundant aromatic natural polymer, isolated from biomass as a byproduct of the pulp and bioethanol processes. Lignin has different hydroxyl groups, including aliphatic, phenolic, and carboxylic acid groups. Phenolic hydroxyl (OH) groups are categorized into three moieties: syringyl (S), guaiacyl (G), and p-hydroxyphenyl (H). Hardwood lignin is composed of G and S units with low H units, while softwood lignin mostly consists of G units with traces of H units. In contrast, lignin from herbaceous plants includes both G and S units and a high amount of H units. Due to the presence of phenolic hydroxyl groups in lignin's structure, lignin is an alternative raw material to substitute BPA in epoxy resin formulation.

“Unmodified lignin” as used herein refers to lignin that has been separated from other components of its lignocellulosic biomass feedstock, such as the cellulose, hemicellulose, and other plant material components. Such separation processes (e.g., Kraft, soda, organosolv, sulfite, enzymatic hydrolysis, and ionic liquid) to isolate lignin from biomass may hydrolyze or otherwise fragment larger lignin molecules into smaller fragments, but this fragmentation and molecular weight reduction is still considered to provide an unmodified lignin as used herein in the corresponding compositions and methods. Such isolated lignins, which are also known as technical lignins, have not been subjected to further modifications or fragmentations, and are considered to provide an unmodified lignin as used herein in the corresponding compositions and methods. Modifications (or chemical modifications) that are generally avoided for the lignin used herein can include one or more of demethylation, phenolation, hydroxymethylation, etherification, depolymerization, and fractionation to monomer, dimers, trimers and oligomers.

The unmodified lignin is not particularly limited and generally can include lignin from any lignocellulosic biomass, for example one or more of hardwoods, softwoods, and/or grasses. Plants, in general, are comprised of cellulose, hemicellulose, lignin, extractives, and ash. Lignin typically constitutes 15-35 wt. % of woody plant cell walls, is an amorphous aromatic polymer made of phenylpropane units (e.g., coniferyl alcohol, sinapyl alcohol, p-coumaryl alcohol). The lignin for use according to the disclosure is not particularly limited to the source of lignin or its isolation method. Any type of lignin regardless of the biomass type (hardwood, softwood and grasses) isolated through any extraction methods (such as Kraft, soda, organosolv, sulfite, enzymatic hydrolysis, and Ionic liquid) is suitable for use in the disclosed compositions and articles. In embodiments, the unmodified lignin is isolated from an extraction process such as Kraft extraction, soda extraction, organosolv extraction, enzymatic hydrolysis extraction, ionic liquid, extraction, sulfite extraction, and combinations thereof (e.g., as mixtures or blends of unmodified lignins from different extraction processes).

The unmodified lignin is generally polymeric, as contrasted with various lignin monomers such as one or more of coniferyl alcohol, sinapyl alcohol, and p-coumaryl alcohol. For example, the unmodified lignin can have an average molecular weight (e.g., weight-average molecular weight, M_{w}) of at least 500 g/mol or 800 g/mol. While technical lignins or other commercial lignins isolated from biomass could have some lignin monomers in the distribution of lignin components, the fraction of such lignin monomers in the unmodified lignin is suitably small, for example as reflected by the minimum average molecular weight of the unmodified lignin. In some embodiments, the unmodified lignin contains less than 10, 5, 2, 1, 0.5, 0.2, or 0.1 wt. % lignin monomers relative to the total unmodified lignin.

In embodiments, the unmodified lignin, prior to reaction and/or incorporation into a reaction mixture for formation of the reaction product, suitably can be selected to have one or more properties related to molecular weight, molecular weight distribution, hydroxyl content, and/or hydroxyl content distribution (e.g., content or relative amount of aliphatic hydroxyl groups, phenolic hydroxyl groups, and/or carboxylic hydroxyl groups). Selection of various physical and chemical properties of the unmodified lignin can help to limit, reduce, or prevent crosslinking and/or gel formation during preparation of the epoxidized lignin prepolymer. Representative ranges for suitable properties of the unmodified lignin include one or more of an average molecular weight in a range of 500 to 50000 (e.g., weight-average molecular weight (M_{w}), a polydispersity index (PDI) in a range of 1.2 to 10, an aliphatic hydroxyl content in a range of 0.5 to 7 mmol/g, a phenolic hydroxyl content in a range of 1 to 7 mmol/g, a carboxylic hydroxyl in a range of 0.1 to 2.0 mmol/g, and/or a total hydroxyl content in a range of 2 to 10 mmol/g. Alternatively or additionally, the unmodified lignin can have one or more of a number-average molecular weight (Mₙ) in a range of 500 to 5000 (or 1000 to 3000), a polydispersity in a range of 1.2 to 8 (or 2 to 4), a phenol hydroxyl content in a range of 1 to 7 mmol/g (or 2 to 5 mmol/g), a relative phenol hydroxyl content of at least 45% (or at least 55%) relative to hydroxyl groups of the unmodified lignin, and/or a carboxylic hydroxyl content less than 1 mmol/g (or less than 0.5 mmol/g).

For example, a lower molecular weight and/or a lower polydispersity index can be desirable to promote access to and reactivity of the phenolic (or aromatic) hydroxy groups of the lignin, but lignin with any molecular weight and/or polydispersity can be used. Suitably, the weight-average molecular weight (Mₙ) can be in a range of 500 to 50000, 1000 to 3000, 3000 to 7000, 3000 to 10000, or 10000 to 50000. For example, M_{w} independently can be at least 500, 800, 1000, 1500, 2000, or 3000 and/or up to 1000, 1200, 1500, 2000, 3000, 5000, 7000, 10000, 15000, or 50000, but higher values are possible. Similar ranges can apply to the number-average molecular weight (Mₙ). Alternatively or additionally, the polydispersity index (M_{w}/Mₙ) can be in a range of 1.2 to 10, 1.2 to 5, or 2 to 4, for example being at least 1.2, 1.4, 1.6, 1.8, or 2 and/or up to 1.5, 1.8, 2.0, 3.0, 4.0, 5.0, 6.0, or 10, but higher values are possible.

Similarly, phenolic (or aromatic) hydroxyl groups can be desirable to promote reactivity of the lignin hydroxyl groups with the halogenated alkyl epoxide. For example, in the case of epichlorohydrin (ECH), reactivity with lignin hydroxyl groups is generally greatest for phenolic hydroxyl groups, followed by carboxylic acid hydroxyl groups and then by aliphatic hydroxyl groups. Selection of an unmodified lignin with a relatively higher phenol hydroxyl content can limit or reduce the number of unreacted lignin hydroxyl groups which could otherwise react with epoxy groups during preparation of the epoxidized lignin prepolymer to form undesirable crosslinks. Similarly, selection of an unmodified lignin with a relatively lower carboxylic acid hydroxyl content can limit or reduce potential hydrolysis after formation of the epoxidized lignin prepolymer or the eventual corresponding cured composition, thus increasing the potential service life of the cured composition or coating. In a refinement, the aliphatic hydroxyl content of the unmodified lignin can be in a range of 0.5 to 7 mmol/g, 1 to 4 mmol/g, or 1 to 3 mmol/g, for example being at least 0.5, 1, 1.5 or 2 and/or up to 2, 2.5, 3, 3.5, 4, 5, 6, or 7 mmol/g. In a refinement, the phenol hydroxyl content of the unmodified lignin can be in a range of 1 to 7 mmol/g, 2 to 6 mmol/g, or 3 to 6 mmol/g, for example being at least 1, 1.5, 2, 2.5, 3, or 3.5 and/or up to 3, 3.5, 4, 4.5, 5, 5.5, 6, or 7 mmol/g. Alternatively or additionally, the phenol hydroxyl content can be at least 40, 50, 60, or 70% and/or up to 60, 65, 70, 75, or 80% of the total hydroxyl groups of the unmodified lignin (e.g., aliphatic, phenolic/aromatic, and carboxylic hydroxyl groups combined). Similarly, the phenol hydroxyl content individually can be greater than the aliphatic hydroxyl content individually and the carboxylic hydroxyl content individually. In a refinement, the carboxylic hydroxyl content of the unmodified lignin can be less than 1 mmol/g or 2 mmol/g, for example being at least 0.01, 0.1, or 0.2 and/or up to 0.2, 0.3, 0.4, 0.5, 0.7, 1, 1.5, or 2 mmol/g. In a refinement, the total hydroxyl content of the unmodified lignin can be in a range of 2 to 10 mmol/g, 3 to 9 mmol/g, or 4 to 7 mmol/g, for example being at least 2, 2.5, 3, 3.5, 4, 4.5, or 5 and/or up to 3.5, 4, 4.5, 5, 6, 7, 8, 9, or 10 mmol/g.

In embodiments, epoxy functional groups can be selectively introduced onto the original unmodified lignin. The glycidation and quenching reactions can preferentially or selectively convert and epoxidize phenolic hydroxyl groups and/or carboxylic acid groups in the original unmodified lignin, while aliphatic hydroxyl groups can be substantially unreacted and remain in the epoxidized lignin prepolymer. This selective introduction of epoxy groups and preservation of the aliphatic hydroxyl groups in the epoxidized lignin prepolymer kelps to avoid (excessive) crosslinking or gelation during prepolymer formation, and the remaining aliphatic hydroxyl groups are suitable are reactive curing groups for a subsequent curing reaction to convert the prepolymer to a crosslinked/thermoset epoxy, for example with an added hardener and/or in a waterborne epoxy system.

The selective epoxidation can be characterized by the relative amount of hydroxyl groups in the epoxidized lignin prepolymer compared to the original unmodified lignin prior to epoxidation. For example, the epoxidized lignin prepolymer can have an aliphatic hydroxyl content of at least 50, 60, 70, 80, or 90% and/or up to 80, 90, 95, 98, or 100% relative to an aliphatic hydroxyl content of the unmodified lignin, prior to incorporation into the reaction product. Alternatively or additionally, the epoxidized lignin prepolymer can have a phenolic hydroxyl content of up 0.1, 1, 2, 5, 10, 15, 20, 30, or 40% and/or at least 0.001, 0.01, 0.1, 1, 2, or 5% relative to a phenolic hydroxyl content of the unmodified lignin, prior to incorporation into the reaction product. Thus, in some embodiments, all or substantially all of the phenolic hydroxyl groups in the unmodified lignin are reacted and epoxidized in the resulting prepolymer. In various embodiments, the carboxylic hydroxyl groups can be preserved in the prepolymer or reacted in side reactions. For example, the epoxidized lignin prepolymer can have a carboxylic hydroxyl content of up 5, 10, 15, 20, 30, 40, 50, 60, 70, 80, 90, or 100% and/or at least 0.01, 0.1, 1, 2, 5, 10, 20, 35, or 50% relative to a carboxylic hydroxyl content of the unmodified lignin, prior to incorporation into the reaction product. The foregoing percentages can be on a number basis (e.g., mmol or equivalents of OH groups for unmodified lignin relative to epoxidized lignin) or a combined number/weight basis (e.g., mmol/g or eq./g of OH groups for unmodified lignin relative to epoxidized lignin).

The selective epoxidation also can be characterized by a selectivity ratio corresponding to the relative amount of phenolic hydroxyl groups (or phenolic hydroxyl groups and carboxylic hydroxyl groups combined) reacted/epoxidized relative to the amount of aliphatic hydroxyl groups reacted/epoxidized. Suitably, the selectivity ratio is at least 5, 10, 20, 50, 100, 200, 500, or 1000 and/or up to 100, 200, 500, 1000, 2000, 5000, or 10000. Put another way, suitably at least 60, 70, 80, 90, 95, 98, or 99% and/or up to 80, 90, 92, 95, 98, 99, 99.6, or 100% of the hydroxyl groups that are reacted/epoxidized are phenolic (or phenolic+carboxylic) hydroxyl groups in the original unmodified lignin. The foregoing ratios and percentages can be on a number or weight basis.

The selective epoxidation also can be characterized by the absolute amount of hydroxyl groups in the epoxidized lignin prepolymer. For example the aliphatic hydroxyl content of the epoxidized lignin prepolymer can be in a range of 0.5 to 7 mmol/g, 1 to 4 mmol/g, or 1 to 3 mmol/g, for example being at least 0.5, 1, 1.5 or 2 and/or up to 2, 2.5, 3, 3.5, 4, 5, 6, or 7 mmol/g. Alternatively or additionally, the phenol hydroxyl content of the epoxidized lignin prepolymer can be up to 0.01, 0.1, 0.2, 0.5, 1, or 2 mmol/g and/or at least 0.001, 0.01, 0.1, 0.2, or 0.5 mmol/g. Similarly, the carboxylic hydroxyl content of the epoxidized lignin prepolymer can be up to 0.1, 0.2, 0.5, 1, 1.5, or 2 mmol/g and/or at least 0.01, 0.1, 0.2, or 0.5 mmol/g.

The halogenated alkyl epoxide generally has an alkyl-substituted epoxide or oxirane ring with at least one halogen atom or functional group (e.g., Cl, Br, I), for example as a substituent on an alkyl group attached to one of the two epoxide carbon atoms. In embodiments, the halogenated alkyl epoxide include epichlorohydrin (“ECH” or 2-(chloromethyl)oxirane). In other embodiments, other halogenated alkyl oxiranes can be used such as 2-(halomethyl)oxiranes or more generally (haloalkyl)oxiranes (e.g., with the halogen group at a terminal position on the alkyl group opposite the epoxide group)

In embodiments, the halogenated alkyl epoxide is a biobased material. The halogenated alkyl epoxide can be derived from a biobased feedstock, for example having a carbon isotope signature corresponding to recently fixated carbon and not from a radioactively degraded petroleum source. For example, biobased-ECH can be formed from a biobased glycerin feedstock (e.g., obtained from natural fatty acid (tri)glycerides or other natural glycerin sources). In other embodiments, petroleum-based ECH or other halogenated alkyl epoxides can be used.

### Epoxidized Lignin Prepolymer

The epoxidized lignin prepolymer reaction product is generally characterized by a high degree of epoxide functionality and a high solubility in one or more organic (or non-water) solvents. The epoxidized lignin prepolymer has an epoxide functionality in a range of 2 to 8 and a high solubility in various common organic solvents, for example being completely soluble at concentrations of at least 10 wt. % or 0.1 g/ml in a reference solvent such as dimethyl formamide, acetone, or methyl ethyl ketone. The high solubility permits incorporation of the epoxidized lignin prepolymer into an epoxy system which cures after addition of curing agents at high enough concentrations to allow replacement of conventional epoxide prepolymers at levels up to 100% replacement, which in turn reduces the amount of dangerous or toxic components in conventional epoxides. In embodiments, the phenolic portion of the epoxidized lignin prepolymer can be a partial or substantial replacement of conventional (e.g., petroleum-based) epoxide prepolymers, for example being at least 10, 20, 30, 40, 50, 60, 70, 80, 90, 92, 95, 98, 99, or 100% and/or up to 30, 40, 50, 60, 70, 80, 85, 90, 95, 98, 99, or 100% derived from or otherwise based on the original unmodified lignin, for example on a weight basis. Put another way, the epoxidized lignin prepolymer can include various portions of other non-lignin phenolic materials (e.g., bisphenol A), for example being free or substantially free from other non-lignin phenolic materials. When other non-lignin phenolic materials are included, they suitably are present in amounts of up to 1, 2, 3, 5, 10, 15, 20, 30, 40, 50, or 60% and/or at least 0.01, 0.1, 1, 2, 5, 7, 10, 15, 20, or 30%, for example on a weight basis. The foregoing amount ranges for the phenolic portion of the epoxidized lignin prepolymer can equivalently apply to the relative amounts of unmodified lignin and non-lignin total phenolic materials reacted to form the prepolymer.

The epoxide functionality for the epoxidized lignin prepolymer represents the average number of epoxide (or oxirane) functional groups per lignin macromolecule (e.g., as a number- or weight-average). The epoxide functionality can be expressed as an amount of epoxy groups (e.g., mol epoxy/g lignin) times the lignin number-average molecular weight (Mₙ) (e.g., g lignin/mol lignin). In some embodiments, the epoxide functionality can be at least 2, 2.5, 3, 3.5, or 4 and/or up to 4, 4.5, 5, 5.5, 6, 7, or 8. The epoxide functionality can be controlled by selection of the lignin source (e.g., having a source-dependent distribution of functional groups reactive to epoxidation) and/or relative amount of halogenated alkyl epoxide reacted with the unmodified lignin and/or the relative amount of phase catalyst transfer. Different epoxide functionality values can be desirable depending on the relative degree of crosslinking desired in the eventual cured thermoset product, which degree of crosslinking is proportional to the epoxide functionality.

The epoxidized lignin prepolymer reaction product, which can also be referenced as an epoxide-functional resin as the prepolymer, is generally substantially non-crosslinked. The substantial lack of crosslinking in the prepolymer is advantageous, because it prevents the reaction product from gelling or precipitating during formation of the epoxidized lignin prepolymer, and it allows the reaction product to be dissolved at sufficiently high concentrations in a variety of useful organic solvents. Such high solubility permits incorporation of the epoxidized lignin prepolymer into an epoxy system which cures after addition of curing agents (e.g., for both 1K or 2K formulations) at high enough concentrations to allow replacement of conventional epoxide prepolymers such as DGEBA at levels of at least and/or up to 80, 90, or 100% replacement, which in turn reduces the amount of dangerous or toxic components such as BPA (e.g., as a health or environmental hazard) used in a cured coating or other products. Such reduction of dangerous components is achieved with replacement by the epoxidized lignin prepolymer, which is a biobased component.

In embodiments, the reaction product and/or corresponding epoxidized lignin prepolymer has high solubility in common organic solvents, for example being miscible or completely dissolvable in an organic reference solvent at 20° C. or 25° C. in an amount of at least 0.05 g/ml, 0.1 g/ml and/or up to 0.5 g/ml or 1 g/ml. Alternatively or additionally, the solubility of the epoxidized lignin prepolymer in an organic reference solvent at 20° C. or 25° C. can be expressed on a w/w basis, for example being soluble in amounts of at least 10, 15, 20, 25, 30, 35, or 40 wt. % and/or up to 20, 30, 40, 50, 60, 70, or 80 wt. % of epoxidized lignin prepolymer relative to the total reference solution (i.e., prepolymer and solvent combined). Such values reflect concentrations at which the epoxidized lignin prepolymer is 100% soluble in a given solvent after mixing at room temperature to provide a solution with no residual solid. The reference solvent is not particularly limited and can include those solvents useful for forming a curable epoxy formulation, for example including dimethyl formamide (DMF), dimethyl sulfoxide (DMSO), dichloromethane (DCM), acetone, methyl ethyl ketone, ethyl lactate, etc. The reference solvent is selected as a convenient means to characterize the product solubility, but it does not limit the solvents used when forming a cured thermoset using the prepolymer product.

### Methods and Products

The epoxidized lignin prepolymer is generally formed in a suitable reaction mixture or medium by performing a glycidation reaction followed by a quenching step. In the glycidation reaction, an unmodified lignin and a halogenated alkyl epoxide are reacted to form a lignin adduct having pendant epoxide groups and pendant halogenated alkyl hydroxy groups. The subsequent quenching step includes adding a base in a controlled manner to the lignin adduct (e.g., in the reaction medium) to convert pendant halogenated alkyl hydroxy groups to pendant epoxide groups via a ring-closing or epoxide re-formation step, while limiting or preventing gelation of the reaction mixture. This quenching step increases the overall epoxide functionality of the epoxidized lignin prepolymer while avoiding (excess) crosslinking, which in turn provides the high solubility characteristics of the epoxidized lignin prepolymer.

In embodiments, the reaction mixture or medium further includes a solvent. The solvent is not particularly limited and can be any suitable liquid solvent medium for the reaction mixture that can solubilize or be miscible with the unmodified lignin and the halogenated alkyl epoxide. Typical solvents can include dimethylformamide (e.g., for any lignin in general) and acetone (e.g., for organosolv lignin in particular). More general examples of solvents include one or more of acetone, tetrahydrofuran (THF), 2-butanone, other ketones (e.g., methyl n-propyl ketone, methyl isobutyl ketone, methyl ethyl ketone, ethyl n-amyl ketone), esters (e.g., C₁-C₄ alkyl esters of C₁-C₄ carboxylic acids, such as methyl, ethyl, n-propyl, butyl esters of acetic acid such as n-butyl acetate, etc., n-butyl propionate, ethyl 3-ethoxy propionate), biobased solvents such as biobased esters (e.g., C₁-C₄ alkyl esters of C₂-C₆ hydroxycarboxylic acids, such as methyl, ethyl, n-propyl, butyl esters of lactic acid such as ethyl lactate), dimethylformamide, dimethyl carbonate, 1,4 dioxane, dichloromethane, dimethylformamide (DMF), dimethylsulfoxide (DMSO), etc., for example as single solvents or solvent mixtures. The solvent or solvent mixture can be included in any suitable amount in the reaction mixture, for example in amount of at least 5, 10, 15, 20, or 30 wt. % and/or up to 20, 30, 40, 50, 60, 70, or 80 wt. % relative to the total amount of solvent(s), (initial) unmodified lignin, and (initial) halogenated alkyl epoxide in or added to the reaction mixture.

The lignin adduct resulting from the glycidation reaction is generally an intermediate product mixture prior to formation of the eventual epoxidized lignin prepolymer after quenching. The lignin adduct includes pendant epoxide groups resulting from SN2 addition during glycidation. The lignin adduct also includes pendant halogenated alkyl hydroxy groups resulting from epoxide ring-opening addition during glycidation. Both pendant functional groups can be added to the lignin substrate by reaction at a hydroxyl site of the starting unmodified lignin (e.g., anionic form of the hydroxyl site after addition of suitable catalyst).

In embodiments, the glycidation reaction can be performed at a temperature in a range of 50° C. to 70° C. or 50° C. to 100° C. The glycidation reaction more generally is performed at an elevated temperature (e.g., above 25° C.) to improve the rate and yield of the epoxidation reaction, thereby improving the epoxide functionality of the eventual (final) reaction product and epoxidized lignin prepolymer. Excessively high reaction temperatures, however, can undesirably lead to crosslinking and/or thermal run-away. Accordingly, suitable reaction temperatures for the glycidation reaction can be in the range of 50° C. to 70° C. or 55° C. to 65° C., for example about 65° C. In other embodiments, for example when using a relatively high-boiling solvent medium (e.g., solvent boiling point of at 120° C. or 140° C. and/or up to 200° C. or 300° C.) such as ethyl lactate or otherwise, higher glycidation temperatures can be used, for example in the range of 60° C. to 100° C. or 70° C. to 90° C. Suitable reaction times (or residence times in a continuous reactor) for the glycidation reaction can be in the range of 0.5-5 hr or 1-4 hr, for example about 3 hr. Suitably, the glycidation reaction is performed in the absence of a base or base catalyst (e.g., NaOH, whether the same or different from the base added during quenching).

The quenching reaction is generally performed after or otherwise in series with the glycidation reaction. The base is not particularly limited, and aqueous sodium hydroxide (or other alkali metal or alkaline earth metal hydroxide) is conveniently used a low-cost base to perform the quenching reaction while maintaining the epoxidized lignin prepolymer in solution in the combined resulting solvent/aqueous medium. By adding the base to the reaction mixture in a slow, controlled manner during the quenching reaction, the base is preferentially consumed in a ring-closing reaction with the pendant halogenated alkyl hydroxy groups to re-form the epoxide group. For example, ring-opening addition with ECH can form a pendant —OCH₂CH(OH)CH₂Cl group as the halogenated alkyl hydroxy group. Reaction with NaOH as a representative base can abstract an H and Cl atom from the halogenated alkyl hydroxy group to re-form the epoxide group pendant on the lignin along with NaCl and H₂O byproducts. In contrast, if the entire amount of base were added to the reaction mixture initially or otherwise at a large excess early in the quenching reaction, the excess base could undesirably cause excessive crosslinking and gelation by reaction between existing epoxide groups (e.g., those resulting from SN2 addition during glycidation) and existing hydroxyl groups (e.g., those resulting from ring-opening during glycidation or those originally in the unmodified lignin that were not converted during glycidation). Accordingly, slow, controlled addition of the base to the reaction mixture (e.g., dropwise addition) can limit or prevent undesirable crosslinking and gelation, for example by slowly adding the entire amount of base to the reaction mixture distributed in smaller amounts over the total quenching reaction time.

While some crosslinking might occur during the quenching reaction, any such crosslinking is reduced or minimized to an extent such that precipitation of an insoluble crosslinked or networked reaction product, which would be indicative of gelation, is not observed. Put another way, the formation of new bonds linking lignin structures is reduced, resulting in a prepolymer that has high solubility in organic solvent. Accordingly, essentially all of the reaction product after glycidation and quenching remains soluble in the final reaction medium, which contains any solvent from the initial reaction medium, the epoxidized lignin prepolymer reaction product, any water added with the base in aqueous form, etc. For example, at least 90, 95, 98, or 99 wt. % and/or up to 98, 99, or 100 wt. % of the reaction product remains soluble in the final reaction medium. Alternatively, not more than 1, 2, 5, or 10 wt. % of the reaction product precipitates or gels in the reaction medium. Precipitation, gelation, and/or the absence thereof can be suitably monitored/confirmed via visible inspection, filtration, or optical interrogation (e.g., to confirm whether any precipitate formed during the reaction). The desired, substantially uncrosslinked/non-gelled reaction product that has high solubility in various other solvents (e.g., for 1K or 2K coating formulations) can be recovered from the final reaction medium, for example by first removing (e.g., filtering) any minor amounts of precipitate that did form, and then recovering the desired product by inducing precipitation of the desired product with addition of a large excess of (de-ionized) water.

In embodiments, the quenching reaction can be performed at a temperature up to 30° C. The quenching reaction more generally is performed at a low or ambient (e.g., room-) temperature, to allow the ring-closing/epoxide re-formation reaction to proceed without substantial crosslinking or gelation. Accordingly, suitable reaction temperatures for the quenching reaction can be in the range of 5° C. to 30° C., 5° C. to 15° C., 10° C. to 15° C., 10° C. to 20° C., or 15° C. to 25° C., for example about 10° C., 150° C., 20° C. or 25° C. Similarly, the quenching reaction can be performed over a reaction time of 6 hr to 24 hr. Suitable reaction times (or residence times in a continuous reactor) for the quenching reaction more generally can be in the range of 1-24 hr or 3-12 hr, for example about 6 hr or 8 hr. At relatively low quenching temperature (e.g., 15° C. or lower), a suitably rapid quenching reaction can be performed without substantial crosslinking or gelation by using a more concentrated base solution (although still with slow or controlled addition), for example using an aqueous NaOH or other base solution at a concentration of at least 5, 8, 10, 12, or 15 wt. % and/or up to 10, 15, 20, or 25 wt. %. For example, the quenching reaction time can be at least 0.5, 1, 2, 3, 4, 6, 8, or 10 hr and/or up to 1, 2, 3, 6, 8, 10, 12, 16, or 24 hr. The quenching reaction time can reflect the time over which the total amount of base for ring-closing/epoxide re-formation is added.

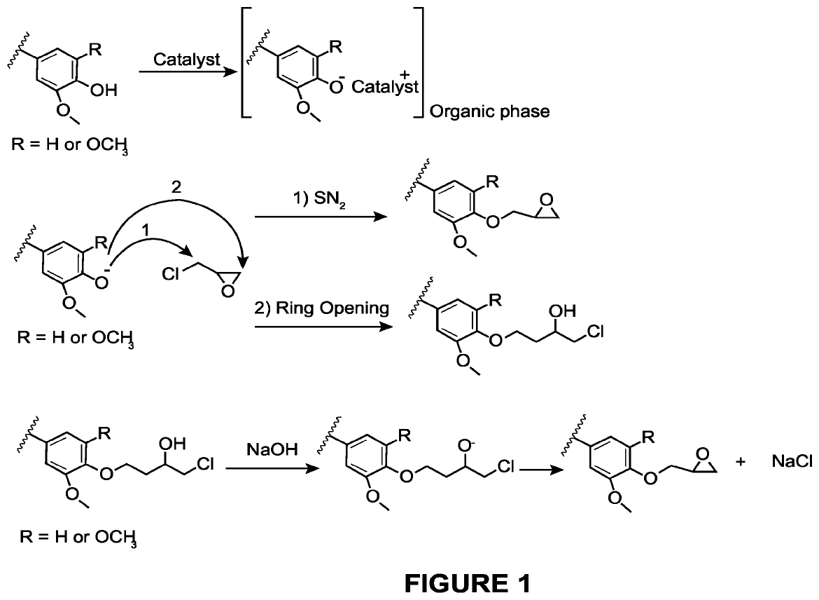

In embodiments, the glycidation reaction and the quenching reaction can be performed in the presence of a phase-transfer catalyst. The phase-transfer catalyst generally serves to transfer an anionic form of hydroxyl groups to an organic phase (e.g., —O—), for example which is stabilized in the reaction medium by a corresponding cation from the phase-transfer catalyst. The anionic form of the hydroxyl groups is amenable to reaction with the halogenated alkyl epoxide via SN2 and ring-opening addition. Phase-transfer catalysts are generally known in the art. Suitable phase-transfer catalysts include tetrabutyl ammonium bromide (TBAB) or triethylbenzyl ammonium chloride (TEBAC), for example in a general class of quaternary ammonium salts such a halogen salt (e.g., F, Cl, Br) of an ammonium cation having four alkyl and/or aromatic substituents. The representative reaction scheme in FIG. 1 illustrates formation of the anionic —O⁻ groups, reaction of same with halogenated alkyl epoxide during glycidation, and epoxide re-formation/ring closing during quenching. The phase-transfer catalyst can be included during the quenching reaction (e.g., added as an additional portion relative to that added during glycidation) to provide additional time for glycidation for unreacted ECH and lignin hydroxyl groups during the quenching, thus improving the epoxy content of final reaction product, because the phenolic ion transfer in the last step is still ongoing and causes higher net epoxy content.

The disclosure further relates to a cured epoxy resin and a corresponding article including a substrate coated with the cured epoxy resin. The cured epoxy resin includes a crosslinked reaction product between (i) the epoxidized lignin prepolymer according to any of the variously disclosed embodiments and refinements and (ii) a hardener. The hardener is suitably a polyfunctional monomer having functional groups reactive with the epoxide (oxirane) groups of the epoxidized lignin prepolymer, which react via ring-opening to covalently bond the hardener to the prepolymer and form a pendant hydroxyl group. The cured epoxy resin is generally a networked or thermoset material. The cured epoxy resin according to the disclosure can be used for the same applications as a conventional cured epoxy, for example as a (protective) coating or paint on a substrate, an adhesive material joining two opposing substrates, and composites serving as polymeric matrix in composite products mixed with different type of natural or synthetic fibers/filler or extenders, etc.

The hardener is not particularly limited and can be selected from various conventional hardeners used for epoxy resins. For example, the hardener can include one or more of polyfunctional amines, acids, acid anhydrides, phenols, alcohols, and/or thiols. In some embodiments, the hardener is a biobased material. Example materials suitable as biobased hardeners include biobased amines, phenalkamines, furanyl amines, anhydrides, and polyphenols. As illustrated in the examples, a phenalkamine isolated from cashew nutshells is a suitable biobased hardener and is available as the commercial product CARDOLITE GX-3090.

In embodiments, the epoxidized lignin prepolymer is suitably a 100% replacement for conventional epoxide polymer or prepolymer resins prior to curing, such as bisphenol-A-diglycidyl ether (DGEBA). For example, the epoxidized lignin prepolymer can be substantially the only source of epoxide-hardener crosslinks in the crosslinked reaction product. Accordingly, a composition to be cured/crosslinked including an epoxide-functional component and a hardener component is suitably substantially free from epoxide-functional components other than the epoxidized lignin prepolymer. For example, at least 80, 90, 95, 98, or 99% and/or up to 90, 95, 99, or 100% (e.g., about 100%) of the epoxide-hardener crosslinks in the crosslinked reaction product are from the reaction of the epoxidized lignin prepolymer with the hardener, for example on a weight basis (of the epoxide-functional components) or a number/molar basis (of the epoxide groups prior to curing).

In embodiments, the cured epoxy resin is 100% biobased. The cured epoxy resin can be 100% biobased when the halogenated alkyl epoxide is a biobased material (e.g., biobased ECH) and the hardener is a biobased material, given that the lignin substrate forming the primary basis for the cured epoxy resin is also a biobased material. In other embodiments, the cured epoxy resin is at least and/or up to 70, 80, 90, 95, or 100% biobased, for example on a weight basis.

The cured epoxy resin can be formed by reacting the epoxidized lignin prepolymer with a hardener. The epoxidized lignin prepolymer and the hardener can be provided in a liquid formulation, for example dissolved in a solvent medium (e.g., those described above for the reaction medium). The epoxidized lignin prepolymer and the hardener can be provided in the same or separate curing formulations (e.g., 1K or 2K formulations). The high solubility of the epoxidized lignin prepolymer in various solvents permits its inclusion at relatively high concentration levels in the liquid formulation to be cured, for example at least 10, 15, 20, 25, 30, 35, or 40 wt. % and/or up to 20, 30, 40, 50, 60, or 70 wt. % in a suitable organic solvent at 20° C. or 25° C. at high enough concentrations to allow replacement of conventional epoxide prepolymers.

In the coated article embodiment, the substrate can be metal, plastic, a different thermoset material, glass, wood, fabric (or textile), a composite, or a ceramic. The substrate is not particularly limited, and generally can be formed from any material. For example, the substrate can be a metal, plastic, glass, wood, fabric (or textile), or ceramic material. Examples of specific metals include steel, aluminum, copper, etc. Examples of specific plastics include polyvinyl alcohol (PVOH), ethylene vinyl alcohol (EVOH), polyethylene terephthalate (PET), polypropylene (PP), polyethylene (PE), polylactic acid (PLA), etc. Suitable wood materials can be any type of wood commonly used in home, office, outdoor settings, wood composites, mass timber and engineered wood products. Suitable glass materials can be those used for building windows, automobile windows, etc. In some embodiments, the substrate is a top layer of a coating or series of coatings on a different underlying substrate. For example, the coated article can include a substrate material as generally disclosed herein, one or more intermediate coatings on the substrate (e.g., a polyurethane coating, an acrylic coating, another primer coating, etc.), and the cured epoxy resin on the one or more intermediate coatings as the final, external coating on the coated article.

The cured epoxy resin can have any desired thickness on the substrate(s). In embodiments, the cured epoxy resin has a thickness ranging from 0.01 μm to 500 μm, for example at least 0.01, 10, 20, 50, or 100 μm and/or up to 200, 500 μm. Typical cast coatings can have thicknesses of 10 μm to 100 μm. Typical spin coatings can have thicknesses of 0.05 μm or 0.10 μm to 0.20 μm or 0.50 μm. Multiple coating layers can be applied to substrate to form even thicker layers of the cured epoxy resin (e.g., above 500 μm or otherwise) if desired.

In embodiments, the epoxidized lignin prepolymer can be provided in the form of an aqueous curable epoxy composition including an aqueous medium, an organic phase dispersed in the aqueous medium, an epoxidized lignin prepolymer in the organic phase, and a hardener in the organic phase. The organic phase can simply be a liquid hardener (e.g., a water-insoluble material) that serves as a pH increaser or solvent/liquid medium for the epoxidized lignin prepolymer which is dissolved therein. The curable composition can thus have an aqueous continuous medium with droplets of miscible prepolymer and hardener dispersed throughout the aqueous medium. The aqueous dispersion can be stored until use, whereupon it can be applied to a surface to evaporate water and complete curing (e.g., initial curing can begin while in aqueous dispersion before use, albeit at a slow rate).

### EXAMPLES

The following examples illustrate the disclosed compositions and methods, but are not intended to limit the scope of any claims thereto.

### Example 1: Epoxidized Lignin Prepolymers

This example illustrates the use of thirteen unmodified lignin samples from different biomass sources and isolation processes to entirely replace bisphenol-A (BPA) in the formulation of solubilized epoxy resins using the disclosed method. Reactivity of different lignins toward biobased epichlorohydrin (ECH) was characterized, and the epoxy contents of various biobased epoxidized lignins were measured. Lignins with higher phenolic hydroxyl content and lower molecular weights were more suitable for replacing 100% of toxic BPA in the formulation of epoxy resins. Moreover, the two epoxidized lignin samples with the highest epoxy content were cured using a biobased hardener, which showed similar thermomechanical performances to a petroleum-based (DGEBA) epoxy system.

Materials: Thirteen commercially available lignin samples from different plant sources and isolation processes were provided by Advanced Biochemical Co., Ltd. (Thailand). Other chemicals used include: N,N-Dimethylformamide (DMF) (99.8%, extra dried, Acroseal, Acros Organics); tetrabutylammonium bromide (TBAB) (Tokyo Chemical Industry Co., LTD, Purity >98%); biobased ECH (Advanced Biochemical Thailand Co., Ltd, 99.9%); biobased phenalkamide epoxy curing agent/hardener (GX-3090; Cardolite); and bisphenol A diglycidyl ether (DGEBA) (EPON 828; E. V. Roberts). Additional reagents were purchased and used as received from various commercial suppliers.

Lignin Properties: Table 1 shows the measured physicochemical properties of the different lignin samples used in this example. In the sample ID, the lignin isolation process is denoted by K (kraft), S (soda), or O (organosolv); and the biomass source is denoted by SW (softwood), HW (hardwood), Ba (bagasse), PS (peanut shell), and WS (wheat straw). In Table 1, ash and elemental content of the lignin are expressed as a percent, Mₙ is the number-average molecular weight, M_{w} is the weight-average molecular weight, PDI is the polydispersity index (M_{w}/Mₙ), and T_{g} is the glass transition temperature.

TABLE 1
Measured Lignin Properties

| | Ash | | | | | | | | |
|---|---|---|---|---|---|---|---|---|---|
| | Content | C | H | N | S | Mn | Mw | | Tg |
| Sample ID | (%) | (%) | (%) | (%) | (%) | (Da) | (Da) | PDI | (° C. ) |
| 1-K-SW | 0.52 (0.10) | 62.9 | 5.9 | 0.1 | 1.7 | 1820 | 6950 | 3.8 | 144 |
| 2-K-HW | 1.39 (0.14) | 60. | 5.8 | 0.2 | 0.3 | 2690 | 12350 | 4.6 | 164 |
| 3-S-HW | 4.84 (0.11) | 58.5 | 5.8 | 0.8 | 1.9 | 1890 | 6410 | 3.4 | 158 |
| 4-O-WS | 0.50 (0.20) | 63.7 | 5.7 | 0.5 | 0.1 | 1870 | 5380 | 2.9 | 174 |
| 5-O-Ba | 3.37 (0.04) | 61.1 | 5.5 | 0.7 | 0.1 | 2340 | 11450 | 4.9 | 130 |
| 6-O-PS | 0.88 (0.02) | 63.9 | 6.6 | 1.8 | 1.1 | 1750 | 9306 | 5.3 | 83 |
| 7-O-HW | 0.47 (0.02) | 62.9 | 6.0 | 0.2 | 0.2 | 1772 | 8202 | 4.6 | 79 |
| 8-K-SW | 0.54 (0.02) | 62.7 | 6.0 | 0.1 | 1.4 | 2030 | 8700 | 4.3 | 159 |
| 9-K-SW | 0.65 (0.01) | 62.9 | 6.0 | 0.1 | 1.3 | 1860 | 7200 | 3.9 | 150 |
| 10-K-HW | 5.19 (0.01) | 58.7 | 5.7 | 0.1 | 1.9 | 1560 | 4020 | 2.6 | 167 |
| 11-K-HW | 1.62 (0.01) | 60.9 | 5.8 | 0.1 | 2.3 | 1360 | 3170 | 2.3 | 146 |
| 12-O-WS | 1.73 (0.06) | 58.1 | 5.8 | 2.1 | 0.2 | 3100 | 15280 | 4.9 | 123 |
| 13-K-SW | 0.75 (0.02) | 63.7 | 6.0 | 0.1 | 1.8 | 1990 | 9320 | 4.7 | 143 |

The ash contents of all lignin samples were measured according to TAPPI T 212 om-93 standard method. Briefly, 1-2 g of each oven-dry lignin sample was added to a pre-weighted crucible and heated in a muffle furnace. The temperature was gradually increased from room temperature to 525° C. at a ramp rate of 5° C./min and then kept at 525° C. for 4 h.

The carbon, hydrogen, and nitrogen contents of lignin samples were measured using a PerkinElmer 2400 Series II CHN elemental analyzer (with helium as carrier gas). After calibration of the instrument with K-factors, 2-3 mg of each sample was inserted into the machine with a minimum of four replicates. The sulfur contents of all lignin samples were measured using Inductively coupled plasma optical emission spectroscopy (ICP-OES), iCAP Duo 6000 series, Thermo Fisher, according to the Association of Official Agricultural Chemists (AOAC) official methods of analysis (922.02 and 980.03).

The molecular weight of lignin samples was measured using gel permeation chromatography (GPC). Since unmodified lignin has very poor solubility in tetrahydrofuran (THF), the mobile phase used in the GPC column, lignin samples were first acetylated to improve their solubility in THF. One gram of each lignin sample was mixed with 40 ml pyridine-acetic anhydride solution (50-50% v/v) and stirred for 24 hours at room temperature and 500 rpm. Then acetylated lignin was precipitated with 150 ml hydrochloric acid solution (pH=1), and the precipitate particles were vacuum filtered (Whatman filter paper grade 1). Next, the residual solids were washed with HCl (1 M) solution three times, followed by DI water several times. Finally, the acetylated lignin samples were left to dry overnight in a vacuum oven at 40° C. The acetylated lignin samples were dissolved in THF (HPLC grade, 5 mg/ml), and filtered using a syringe filter (PTFE, 0.45 μm). The filtrate was injected into the GPC system (Waters, Milford, MA, USA), including a separations module (Waters e2695). The mobile phase was THF (HPLC grade), with a 1 mL/min flow rate. Three 300 mm×7.8 mm Ultrastyragel columns from Waters (100-10K, 500-30K, and 5K-600K A) with THF as the mobile phase were used. Polystyrene standards with molecular weights of 162, 370, 474, 580, 945, 1440, 1920, 3090, 4730, 6320, 9520, 16700, and 42400 Da were used for calibration.

The glass transition temperatures (T_{g}) of the lignin samples were measured using a differential scanning calorimeter (DSC-Q100). About 5-10 mg of oven-dried lignin was placed on an aluminum pan with a heating rate of 20° C./min under a nitrogen flow of 70 ml/min in a heat/cool/heat cycle from 30 to 200° C. for lignin samples. The second cycle was used to calculate T_{g}.

In the kraft process, sodium sulfite (Na₂S) is used during the pulping process, while soda and organosolv processes use aqueous alkali solution (sulfur-free) and organic solvents, respectively. As illustrated in Table 1, overall kraft and soda lignins had higher ash content than organosolv lignins. This is due to residual sodium hydroxide and sodium sulfite that were used during pulping processes and the isolation of lignin from black liquor using sulfuric acids like lignoboost or lignoforce methods. Also, the use of sodium sulfite in the kraft pulping process contributes to higher sulfur contents compared to soda and organosolv lignin samples.

On average, softwood lignins had higher molecular weights (average Mw=8040 Da) than hardwood lignin (average Mw=6800 Da) (Table 1). In softwood, 90% of lignin is composed of coniferyl alcohols, while in hardwoods, the amount of coniferyl alcohol is roughly equal to the amount of sinapyl alcohol. The presence of two methoxy groups on the sinapyl alcohol in hardwood lignin versus one methoxyl group in coniferyl alcohol would limit the formation of 5-5 and dibenzodioxins linkages in the hardwood lignin. Therefore, hardwood lignins have a more linear structure and lower molecular weight compared to softwood lignin. [40] Also, during the pulping process, some intermolecular linkages (like β—O-4) in lignin are broken, affecting lignin properties. For example, on average, kraft lignins had lower molecular weights (Mw=7400 Da) than organosolv lignins (Mw=9900 Da). This could be related to the harsh conditions of the kraft process (high temperature, high pH, and longer time), which might have caused the repolymerization of lignin.

Both the lignin source and extraction method affect the T_{g} of lignin (Table 1). T_{g} of lignin is increased by decreasing methoxy content. On average, herbaceous lignins (130° C.) and lignins isolated through organosolv processes (118° C.) had lower T_{g} than kraft hardwood (143° C.) and softwood (149° C.) lignins.

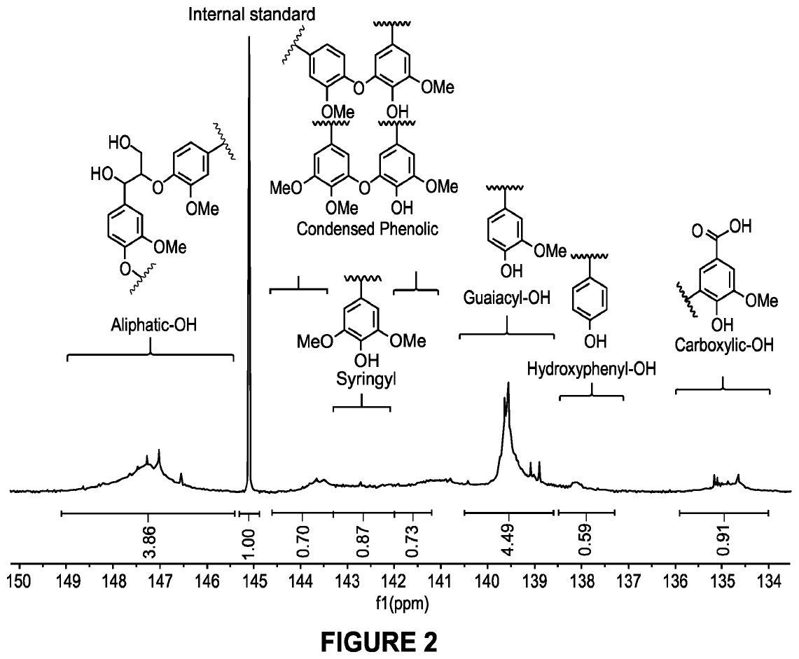

The hydroxyl contents of lignins were measured using ³¹P NMR. Table 2 shows the measured hydroxyl contents of the different lignin samples used in this example. FIG. 2 illustrates the ³¹P NMR spectrum of 1-K-SW as a representative lignin. As illustrated in Table 2, kraft lignin samples, on average, had higher aliphatic OH (2.14 mmol/g), phenolic OH (3.13 mmol/g), and total OH (5.68 mmol/g) contents compared to the other lignin samples isolated through soda and organosolv processes. The higher aliphatic and phenolic OH contents of kraft lignins are results of the cleavage of phenolic ether linkages (β-O—4, α-O-4, and 4-O-5), then subsequent potential recondensation of non-classical linkages, occur as a result of the severity of the cooking process. In addition, a high amount of 5-substituted OH (condensed phenolic) groups in kraft lignin is further evidence of recondensation of new ether bonds and C—C coupled units. Carboxylic acid content was also higher in most isolated kraft lignins, which could be related to the overlapping of aldehyde groups in the lignin structure, which causes overestimation of carboxylic acid content. The presence of thiol groups in alkaline lignins can also cause a reaction with phospholane reagent that forms thiol-phospholane compounds, leading to the overestimation of carboxylic acid content.

TABLE 2
Lignin Hydroxyl Contents (mmol/g)

| | Aliphatic OH | Total Phenolic OH | Carboxylic Acid |
|---|---|---|---|
| Sample ID | (mmol/g) | (mmol/g) | (mmol/g) |
| 1-K-SW | 2.05 | 3.29 | 0.49 |
| 2-K-HW | 2.94 | 2.79 | 0.44 |
| 3-S-HW | 1.8 | 2.08 | 1.03 |
| 4-O-WS | 0.67 | 2.2 | 0.37 |
| 5-O-Ba | 1.24 | 3.72 | 0.51 |
| 6-O-PS | 1.26 | 1.8 | 0.26 |
| 7-O-HW | 1.6 | 3.08 | 0.23 |
| 8-K-SW | 1.94 | 3.41 | 0.53 |
| 9-K-SW | 1.79 | 3.04 | 0.42 |
| 10-K-HW | 1.71 | 1.9 | 0.39 |
| 11-K-HW | 2.19 | 3.78 | 0.12 |
| 12-O-WS | 2.22 | 2.17 | 0.6 |
| 13-K-SW | 2.37 | 3.74 | 0.46 |

For ³¹P NMR analysis, about 40 mg of dry lignin was dissolved in 325 μL anhydrous pyridine/deuterated chloroform mixture (1.6:1, v/v) and 300 μL anhydrous DMF. Since not all lignins were 100% soluble in the mixture of pyridine/chloroform, DMF was added, which resulted in all lignin samples becoming 100% soluble in the ³¹P-NMR solvents. After that, 100 μL cyclohexanol (22 mg/mL) in anhydrous pyridine and deuterated chloroform (1.6:1, v/v) was added as an internal standard, and 50 μL of chromium (Ill) acetylacetonate solution (5.6 mg/mL in anhydrous pyridine and deuterated chloroform 1.6:1, v/v) was added as a relaxation reagent. Finally, 100 μL phosphitylating reagent (2-chloro-4,4,5,5-tetramethyl-1,3,2-dioxaphospholane, TMDP) was added to the mixture. Then, 600 μL of the mixture was transferred to a 5 mm NMR tube, and NMR analyses were performed using an Agilent DDR2 500 MHz NMR spectrometer equipped with 7600AS, running VnmrJ 3.2 A, with a relaxation delay of 5 s, and 128 scans. The hydroxyl content of each lignin sample was calculated based on the ratio of the internal standard peak area (cyclohexanol) to integrated areas over the following spectral regions: aliphatic hydroxyls (149.1-145.4 ppm), cyclohexanol (145.3.1-144.9 ppm), condensed phenolic units (144.6-143.3; and 142.0-141.2 ppm), syringyl phenolic units (143.3-142.0 ppm), guaiacyl phenolic units (140.5-138.6 ppm), p-hydroxyphenyl phenolic units (138.5-137.3 ppm), and carboxylic acids (135.9-134.0 ppm).

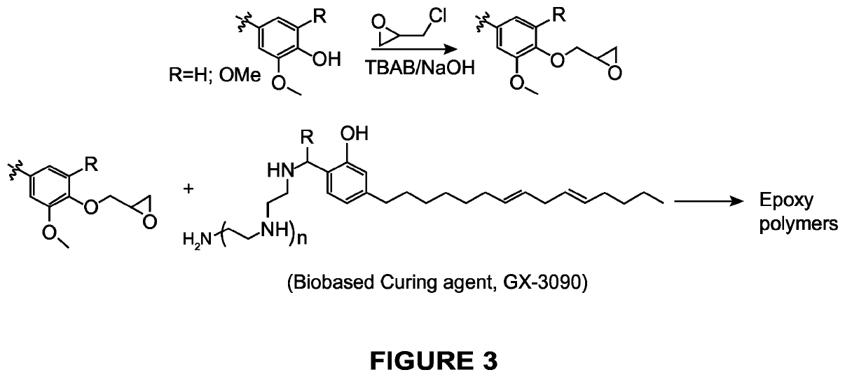

Synthesis of Epoxidized Lignin: First, 4 g of each lignin sample was dissolved in 20 g dimethylformamide (DMF) and stirred for 10 min at room temperature. DMF was used as co-solvent since all lignin samples were completely soluble in DMF. Then 0.4 g tetrabutylammonium bromide (TBAB) and 40 g biobased ECH were added to the lignin/DMF solution and stirred for 3 h at 60° C. under reflux conditions (FIG. 3; top reaction). The mixture was then cooled down to room temperature, and 50 ml of 2% w/w NaOH solution containing 1.2% w/w TBAB was gradually added to the mixture dropwise (one drop every 5 s). Then, the reaction was continued at room temperature for 8 h while stirring at 500 rpm using a magnetic stirrer. After that, 1000 ml deionized (DI) water was added to the solution to precipitate epoxidized lignin. The epoxidized lignin was collected by vacuum filtration and washed several times with DI water to remove formed salt and unreacted ECH. Finally, a vacuum oven was used to dry the epoxidized lignin samples at 40° C., 76 kPa for 48 h.

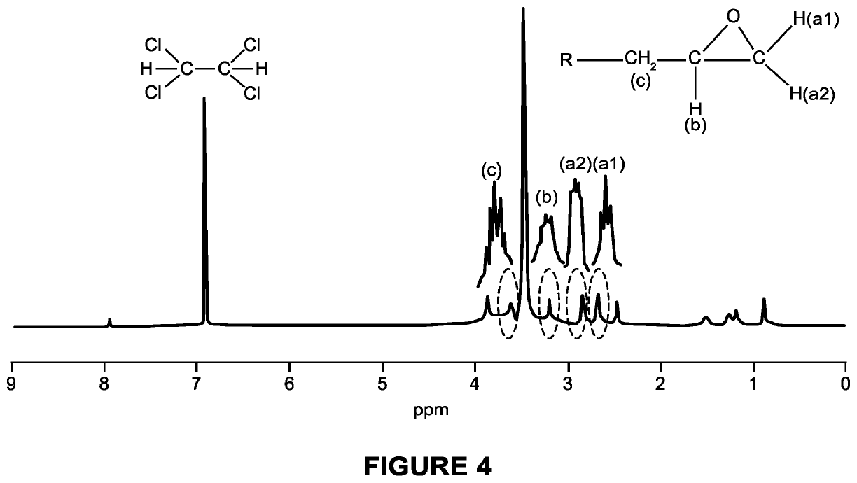

Epoxidized Lignin Properties: The epoxy contents of different epoxidized lignin were measured by titration and 1H NMR methods. FIG. 4 shows the 1H NMR spectrum of epoxidized lignin (1-K-SW). Table 3 summarizes the results based on epoxy content and epoxy equivalent weight (EEW). As shown, there were no significant differences between the results of the two methods. Epoxidation yield based on the total hydroxyl content of lignin is also summarized in Table 3. Samples 4-O-CS and 10-K-HW had the highest yield (89.9% and 66.9%, respectively). The average number of epoxy groups (n) in each macromolecule (epoxy group (mol/g)×Mₙ) is also summarized in Table 3.

TABLE 3
Measured Epoxidized Lignin Properties

| | % Epoxy | | % Epoxy | | | |
|---|---|---|---|---|---|---|
| | Content | EEW | Content | EEW | Yield | |
| Sample ID | (Titration) | (Titration) | (1H NMR) | (1H NMR) | (%) | n |
| 1-K-SW | 9.56 ± 0.26 | 450 | 9.72 | 442 | 38.8 | 4.0 |
| 2-K-HW | 6.79 ± 0.12 | 633 | 7.00 | 614 | 26.4 | 4.4 |
| 3-S-HW | 8.59 ± 0.35 | 501 | 8.21 | 524 | 39.1 | 3.5 |
| 4-O-WS | 12.40 ± 0.31 | 347 | 12.53 | 343 | 89.9 | 5.6 |
| 5-O-Ba | 5.93 ± 0.13 | 725 | 5.87 | 732 | 25.0 | 3.1 |
| 6-O-PS | 5.18 ± 0.12 | 830 | 4.93 | 872 | 34.5 | 2.0 |
| 7-O-HW | 8.75 ± 0.19 | 491 | 8.93 | 481 | 42.3 | 3.7 |
| 8-K-SW | 7.97 ± 0.15 | 539 | 7.88 | 546 | 31.2 | 3.8 |
| 9-K-SW | 10.01 ± 0.24 | 430 | 9.81 | 438 | 43.5 | 4.2 |
| 10-K-HW | 11.27 ± 0.28 | 381 | 11.50 | 374 | 66.9 | 4.1 |
| 11-K-HW | 12.14 ± 0.15 | 354 | 11.98 | 359 | 45.7 | 3.7 |
| 12-O-WS | 4.35 ± 0.08 | 988 | 3.81 | 1129 | 18.9 | 2.5 |
| 13-K-SW | 8.63 ± 0.18 | 498 | 8.98 | 479 | 31.8 | 4.1 |

The titration method for epoxy content determination was a modified version of ASTM D1652-11 using an auto-titrator in which the electric potential was measured to determine the endpoint of the titration. Briefly, 0.2-0.3 g epoxidized lignin was dissolved in 30 ml dichloromethane and 15 ml of a prepared tetraethylammonium bromide reagent (100 g of tetraethylammonium bromide in 400 ml of glacial acetic acid). The resulting solution was stirred for 5 min to ensure the epoxidized lignin was entirely dissolved in the solution. The titration is based on the in-situ formation of hydrobromic acid by the reaction of perchloric acid with excess tetraethylammonium bromide. The hydrobromic acid (HBr) initially reacts with epoxy rings; after all epoxy rings are consumed, the formed HBr drops the pH and increases the potential of the solution, which is used as the endpoint.

The epoxy content determination via 1H NMR was made with the following procedure: About 50 mg of each epoxidized lignin sample was dissolved in 700 μl of deuterated dimethyl sulfoxide (d-DMSO). Then approximately 20 mg internal standard (1,1,2,2 tetrachloroethane) was added. NMR analysis was performed using an Agilent DDR2 500 MHz NMR spectrometer equipped with 7600AS, running VnmrJ 3.2 A, with a 10 s relaxation delay, and 64 scans. The epoxy content of each epoxidized lignin was calculated based on the ratio of following peaks 5 [ppm, DMSO-d₆]: 2.77 (m, 1H); 2.92 (m, 2H); 3.41 (m, 1H), 4.32 (dd, 1H), and 4.64 (m, 1H); these peaks are assigned to the epoxy ring chemical shifts and peaks of internal standard (6.89 ppm, S, 1H). The average number of epoxy groups in each macromolecule (n) was calculated as n=epoxy group (mol/g)×Mₙ.

The results showed that the reactivities of hydroxyl (OH) functional groups in lignin toward ECH, in decreasing order, are phenolic-OH>carboxylic acid>aliphatic-OH. The phenol epoxidation mechanism has three steps. During the epoxidation reaction, a phase transfer catalyst (TBAB) first deprotonates a phenolic hydroxyl group to form a stable phenolate ion. In the second step, deprotonated lignin (phenolate ion) reacts with ECH via two mechanisms: 1) SN2, and 2) ring-opening reactions. In the third step, the chlorinated intermediate is closed in the presence of NaOH to form the epoxy ring. It was found that the hydroxyl groups of lignin could only partially react with ECH. The reaction was also incompletely quenched due to side reactions between lignin's OH groups, ECH, and epoxidized lignin. This may lead to the formation of ether bonds between epoxidized lignin functional groups and ECH. In addition, unreacted hydroxyl groups could potentially react with epoxy groups and form crosslinked products. The formation of crosslinked epoxidized lignin reduces its solubility in organic solvents, negatively affecting the curing reaction of epoxidized lignin with a hardener.

Samples 2-K-HW, 4-O-WS, 9-K-SW, 10-K-HW, and 13-K-SW had a higher average number of epoxy groups (n) compared to other lignin samples. The higher n indicates that the crosslinking density of the cured sample is higher. The weight of epoxidized lignin after the reaction was measured for 11-K-HW to be 4.8 g. Although lignins 4-O-WS, 10-K-HW, and 11-K-HW all have high epoxy contents, based on the overall data, the organosolv wheat straw lignin (4-O-WS) seems to be a better lignin for epoxy resin applications due to its low ash content, low molecular weight, low polydispersity index, and low carboxylic acid content, which will reduce potential hydrolysis and increase the service life of epoxy systems after crosslinking with a hardener.

Modeling: Partial least-square (PLS) regression modeling was used to indentify relationships between different lignin properties and their epoxy contents after epoxidation (reaction with ECH). Mₙ, M_{w}, PDI, and nitrogen content were found to have strong negative correlations with epoxy content, while phenolic hydroxyl content was found to have a strong positive correlation with the epoxy content of lignin. Thus, lignins with lower molecular weight (e.g., weight-average and number-average), lower PDI, lower nitrogen content, and higher phenolic hydroxy contents are more suitable for replacing BPA in epoxy resin formulation.

Cured Epoxy Resins: The two epoxidized lignin samples (4-O-WS and 11-K-HW) with the highest epoxy contents and a commercial DGEBA epoxy resin were cured with a biobased diamine (GX-3090) (FIG. 3; bottom reaction). The epoxy equivalent weight (EEW) of epoxidized lignin was calculated as EEW=4300/(% Epoxy Content). Each hydrogen of the amine group could react with one epoxy group based on active hydrogen equivalent weight (AHEW), then the stoichiometric ratio between the hardener epoxy resins was determined as AHEW/EEW. First, epoxidized lignin samples were dissolved in acetonitrile, then a specific amount of amine hardener GX-3090 was added and mixed according to a given ratio as shown in Table 4. To evaporate the solvent, epoxidized lignin systems were heated at 50° C. for 1 h. All samples were cured at 130° C. for 2 hrs and post-cured at 150° C. for 1 h.

TABLE 4
Cured Epoxy Resins

| | | Mass ratio | E′ | E′ | |
|---|---|---|---|---|---|
| | | (epoxy resin/ | (MPa, | (GPa, | Tan δ |
| Sample ID | EEW | hardener) | 25° C.) | 100° C.) | (° C.) |
| 4-O-WS/GX-3090 | 346.8 | 1/0.21 | 1396 | 701 | 181 |
| 11-K-HW/GX-3090 | 354.2 | 1/0.20 | 1275 | 613 | 173 |
| DGEBA/GX-3090 | 185 | 1/0.37 | 1557 | 331 | 106 |

The thermomechanical properties of the cured resins were analyzed using a TA Instrument Q800 dynamic mechanical analyzer (DMA) with a single cantilever under airflow, and a heating rate of 3.0° C./min from room temperature to 250° C., with a constant deformation frequency of 1 Hz. Samples were polished (by different sandpaper grits 1500, 2000, 2500, 3000, 5000, and 7000) to have smooth surfaces before analysis. Table 4 also summarizes the thermomechanical properties of the cured resins. The storage modulus (E′) and loss modulus (E″) represent the elastic and viscoelastic response of a material, respectively. The ratio of loss modulus to storage modulus is tan δ. The peak temperatures of tan δ and loss modulus are usually reported as glass transition temperature, where a network transits from a glassy state to a rubbery state.

The storage moduli (E′) of all cured samples ranged between 1.3 to 1.6 GPa at 25° C. The storage moduli of lignin-based epoxy networks (1.3-1.4 GPa) were lower than the DGEBA system (1.6 GPa), which could be related to the lower epoxy content of the epoxidized lignins compared to DGEBA resin. This shows that the lignin-based epoxy system had a lower crosslinking density than the petroleum-based epoxy system (DGEBA) prepared using bisphenol A. The organosolv wheat straw lignin (4-O-WS) had a much higher storage modulus than kraft hardwood (11-K-HW). This could be due to the higher average number of epoxy groups (n) and lower molecular weight of 4-O-WS compared to 11-K-HW. At the higher temperature (100° C.), the storage moduli of 4-O-WS and 11-K-HW samples were higher than that of DGEBA, possibly due to the higher glass transition temperature of cured lignin-based epoxy systems. The loss moduli (E″) of 4-O-WS and 11-K-HW thermosets were also higher than that of the DGEBA sample at higher temperatures (120-200° C.), which shows they can better dissipate deformation energy at higher temperatures.

The tan δ peak provides information regarding cured epoxy networks. Generally, higher tan δ peaks correspond to better fracture toughness and higher T_{g}. The width of tan δ represents sample homogeneity, with broader peaks indicating less homogeneous samples. Both lignin-based epoxy thermosets showed significantly broader tan δ peaks, meaning that they are less homogeneous than the DGEBA system, as expected due to the high polydispersity index of lignin compared to BPA. Side reactions at different temperatures as well as multiple functionalities in the system could also result in observing broader tan δ peaks. Also, the glass transition temperatures (T_{g}; recorded from tan δ profile) of epoxidized lignin samples (181° C. and 173° C.) were significantly higher than the T_{g} of the DGEBA system (106° C.), which indicates that lignin-based epoxy systems have higher toughness.

### Example 2: Epoxidized Lignin Prepolymers

This example illustrates an alternative epoxidation process according to the disclosure in which an organic solvent such as DMF used in Example 1 was replaced with ethyl lactate as a biobased solvent. Relative to Example 1, the total reaction time for the two epoxidation steps (i.e., glycidation and quenching) was reduced to about 3 hr as compared to 11 hr.

First, 4 g of unmodified lignin from either a softwood source or a hardwood source was dissolved in 20 g ethyl lactate and mixed for 10 min at room temperature. Then, biobased epichlorohydrin (ECH) (20 eq) and tetrabutylammonium bromide (TBAB) (0.1 eq), based on the total hydroxyl content of lignin, were added to the mixture, and stirred for 2 h at 80° C. under reflux conditions. Next, the mixture was cooled down to 10-15° C., and 20 wt. % NaOH solution (2 eq of total hydroxyl OH) containing 10 wt. % TBAB was slowly added to the mixture. The mixture was stirred for 1 h. After that, the lignin was precipitated by adding 1000 mL deionized (DI) water. Epoxidized lignin was separated using vacuum filtration and washed multiple times to removed salt, unreacted ECH, and ethyl lactate. Lastly, the epoxidized lignin was freeze-dried −52° C. for 6 h.

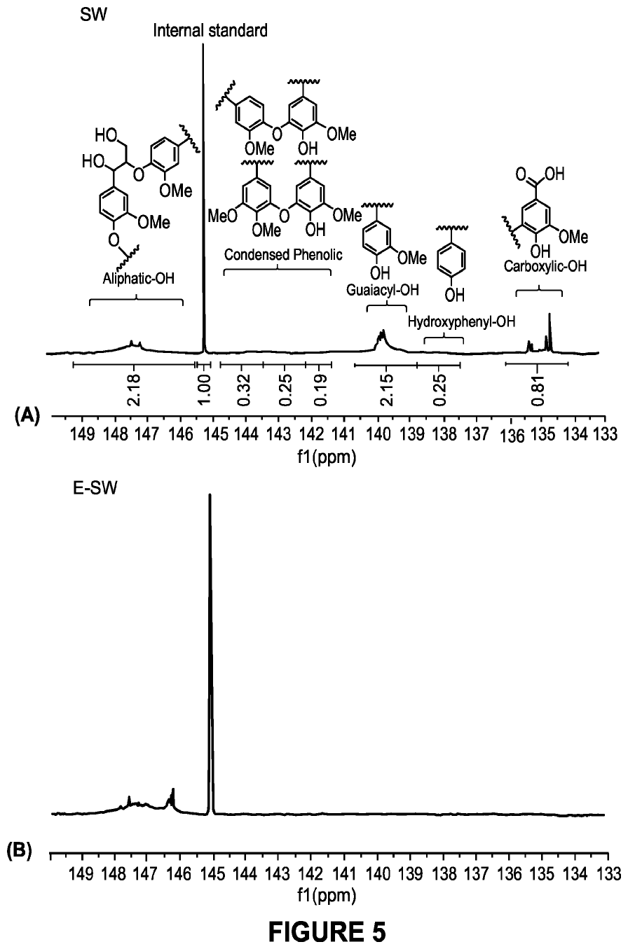

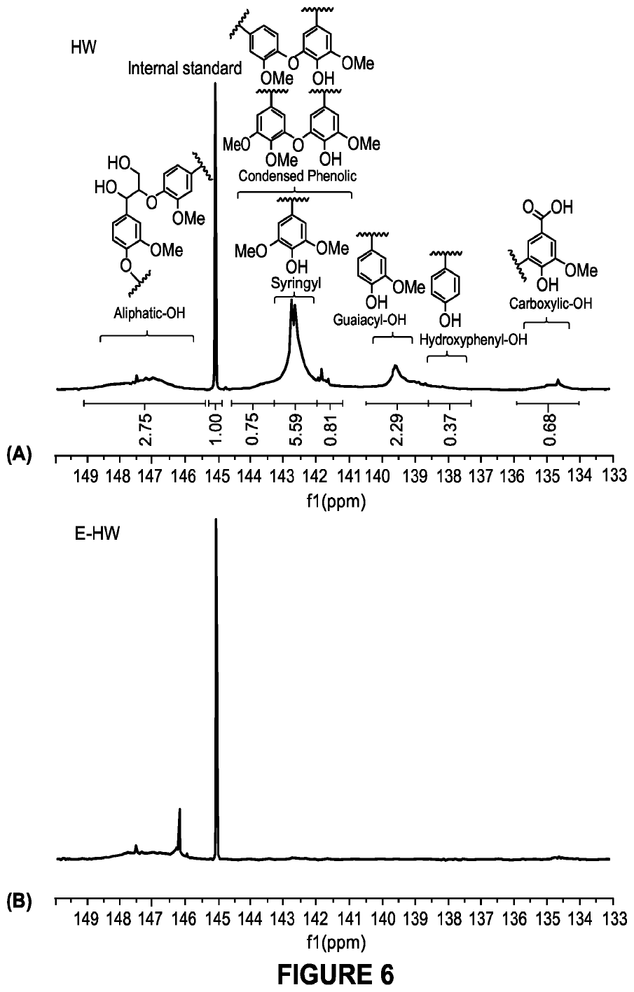

In this example, epoxy functional groups were selectively introduced onto unmodified lignin samples by reacting ECH in ethyl lactate solvent under mild conditions for a relatively short time (only 3 h reaction time). Two different unmodified lignins—one softwood lignin and one hardwood lignin—were modified by epoxidation, and ³¹P NMR analysis confirmed that only phenolic hydroxyl groups and carboxylic acid groups in lignin had undergone epoxidation, while aliphatic hydroxyl groups were left unreacted. In particular, FIG. 5 includes the ³¹P NMR spectra for (A) an unmodified softwood lignin (SW) and (B) a corresponding epoxidized lignin prepolymer (E-SW) showing selective reaction of phenolic hydroxyl groups for epoxidation and retention of aliphatic hydroxyl groups in the final prepolymer. FIG. 6 similarly includes the ³¹P NMR spectra for (A) an unmodified hardwood lignin (HW) and (B) a corresponding epoxidized lignin prepolymer (E-HW). As shown in FIG. 5, the initial phenolic hydroxyl groups (in particular guaiacyl) and carboxylic hydroxyl groups in the unmodified lignin (panel (A)) are essentially all consumed in the epoxidized lignin prepolymer (panel (B)), while the initial aliphatic hydroxyl groups are essentially unreacted from the unmodified lignin and preserved in the epoxidized lignin prepolymer. Further, according to the NMR spectra (not shown), all syringyl (S), guaiacyl (G), and p-hydroxyphenyl (H) units were reacted with ECH completely with a same degree or reactivity. This same effect is shown in FIG. 6, with the difference being that the original HW lignin additionally included syringyl and/or condensed phenolic hydroxyl groups that were consumed via epoxidation. This confirmed the epoxidation reaction in this example avoided side reactions resulting insoluble product that would not otherwise be useful for further applications (e.g., curing, coating, etc.). The unreacted aliphatic hydroxyl groups remaining in the epoxidized lignin prepolymer can be used to formulate waterborne epoxy systems. Furthermore, the epoxy contents of two epoxidized softwood and hardwood kraft lignins were 10.8% and 13.4%, respectively, which were comparable to the epoxy contents of Example 1.

This example illustrates that a typical organic solvent like DMF can be replaced with a non-toxic, biobased organic solvent alternative (ethyl lactate) while reducing total reaction time and achieving similar epoxy contents for the epoxidized lignin prepolymer. The biobased phenalkamide epoxy curing agent/hardener (GX-3090; Cardolite) described in Examples 1 was used with the epoxidized lignin prepolymer of this example to form a waterborne lignin-based epoxy system that could be used in adhesives, coatings, and composite systems.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compositions, processes, kits, or apparatus are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. An epoxidized lignin prepolymer comprising:
a reaction product between:
an unmodified lignin, and
a halogenated alkyl epoxide;
wherein:
the reaction product has an epoxide functionality in a range of 2 to 8; and
the reaction product has a solubility of at least 10 wt. % in dimethyl formamide (DMF).

2. The epoxidized lignin prepolymer of claim 1, wherein the unmodified lignin is derived from a biomass selected from the group consisting of hardwoods, softwoods, grasses, and combinations thereof.

3. The epoxidized lignin prepolymer of claim 1, wherein the unmodified lignin is isolated from an extraction process selected from the group consisting of Kraft extraction, soda extraction, organosolv extraction, enzymatic hydrolysis extraction, ionic liquid, extraction, sulfite extraction, and combinations thereof.

4. The epoxidized lignin prepolymer of claim 1, wherein the unmodified lignin, prior to incorporation into the reaction product, has at least one of the following properties:
an average molecular weight in a range of 500 to 50000;
a polydispersity in a range of 1.2 to 10;
an aliphatic hydroxyl content in a range of 0.5 to 7 mmol/g;
a phenolic hydroxyl content in a range of 1 to 7 mmol/g;
a carboxylic hydroxyl in a range of 0.1 to 2.0 mmol/g; and
a total hydroxyl content in a range of 2 to 10 mmol/g.

5. The epoxidized lignin prepolymer of claim 1, wherein the epoxidized lignin prepolymer has an aliphatic hydroxyl content in a range of 50% to 100% relative to an aliphatic hydroxyl content of the unmodified lignin, prior to incorporation into the reaction product.

6. The epoxidized lignin prepolymer of claim 5, wherein the epoxidized lignin prepolymer has a phenolic hydroxyl content of not more than 1% relative to a phenolic hydroxyl content of the unmodified lignin, prior to incorporation into the reaction product.

7. The epoxidized lignin prepolymer of claim 5, wherein the epoxidized lignin prepolymer has at least one the following properties:
an aliphatic hydroxyl content in a range of 0.5 to 7 mmol/g;
a phenolic hydroxyl content of less than 0.1 mmol/g; and
a carboxylic hydroxyl content of less than 0.05 mmol/g.

8. The epoxidized lignin prepolymer of claim 1, wherein the unmodified lignin, prior to incorporation into the reaction product, has the following properties:
a number-average molecular weight (Mₙ) in a range of 500 to 5000;
a polydispersity in a range of 1.2 to 8;
a phenol hydroxyl content in a range of 1 to 7 mmol/g;
a relative phenol hydroxyl content of at least 45% relative to hydroxyl groups of the unmodified lignin; and
a carboxylic hydroxyl content less than 1 mmol/g.

9. The epoxidized lignin prepolymer of claim 1, wherein the epoxide functionality of the reaction product is in a range of 3.5 to 6.

10. The epoxidized lignin prepolymer of claim 1, wherein the reaction product is soluble in DMF at a concentration of at least 0.1 g/ml at 25° C.

11. The epoxidized lignin prepolymer of claim 1, wherein the halogenated alkyl epoxide comprises epichlorohydrin.

12. The epoxidized lignin prepolymer of claim 1, wherein the halogenated alkyl epoxide is a biobased material.

13. A method for making an epoxidized lignin prepolymer according to claim 1, the method comprising:
performing a glycidation reaction in a reaction mixture comprising an unmodified lignin and a halogenated alkyl epoxide, thereby forming a lignin adduct in the reaction mixture and comprising pendant epoxide groups and pendant halogenated alkyl hydroxy groups; and
performing a quenching reaction in the reaction mixture containing the lignin adduct by adding a base in a controlled manner to the reaction mixture, thereby forming the epoxidized lignin prepolymer of claim 1 by converting at least a portion of the pendant halogenated alkyl hydroxy groups to pendant epoxide groups while limiting or preventing gelation of the reaction mixture.

14. The method of claim 13, comprising performing the glycidation reaction at a temperature in a range of 50° C. to 70° C.

15. The method of claim 13, comprising performing the quenching reaction at a temperature up to 30° C.

16. The method of claim 13, comprising performing the quenching reaction over a reaction time of 6 hr to 24 hr.

17. The method of claim 13, wherein the reaction mixture further comprises a solvent.

18. The method of claim 13, comprising performing the glycidation reaction and the quenching reaction in the presence of a phase-transfer catalyst.

19. A cured epoxy resin comprising:
a crosslinked reaction product between the epoxidized lignin prepolymer of claim 1 and a hardener.

20. The cured epoxy resin of claim 19, wherein the hardener is selected from the group consisting of polyfunctional amines, acids, acid anhydrides, phenols, alcohols, thiols, and combinations thereof.

21. The cured epoxy resin of claim 19, wherein the hardener is a biobased material.

22. The cured epoxy resin of claim 19, wherein the epoxidized lignin prepolymer is substantially the only source of epoxide-hardener crosslinks in the crosslinked reaction product.

23. The cured epoxy resin of claim 19, wherein the cured epoxy resin is 100% biobased.

24. An article comprising:
(a) a substrate; and
(b) a cured epoxy resin according to claim 19 coated on a surface of the substrate.

25. The article of claim 24, wherein the substrate is selected from the group of metal, plastics, a different thermoset material, glass, wood, fabric, composites, and ceramics.

26. The article of claim 24, wherein the cured epoxy resin has a thickness ranging from 0.01 μm to 500 μm.

27. A method for forming a cured epoxy resin, the method comprising:
reacting the epoxidized lignin prepolymer of claim 1 with a hardener.

28. An aqueous curable epoxy composition comprising:
an aqueous medium; and
an organic phase dispersed in the aqueous medium, the organic phase comprising the epoxidized lignin prepolymer of claim 1 and a hardener.
